(19) United States
(12) Patent Application Publication
(10) Pub. No.: US 2024/0340125 A1
(43) Pub. Date: Oct. 10, 2024

(54) EFFICIENT CODEBOOK-BASED INTERFERENCE PREDICTION REPORTING

(71) Applicant: QUALCOMM Incorporated, San Diego, CA (US)

(72) Inventors: Mohamed Fouad Ahmed MARZBAN, SAN DIEGO, CA (US); Wooseok NAM, San Diego, CA (US); Tao LUO, San Diego, CA (US)

(21) Appl. No.: 18/295,569

(22) Filed: Apr. 4, 2023

(51) Int. Cl. H04L 5/00; H04W 72/02; H04W 72/21

(52) U.S. Cl. CPC H04L 5/0032; H04L 5/0096; H04W 72/02; H04W 72/21

(57) ABSTRACT

Methods, systems, and devices for wireless communications at a user equipment (UE) are described. The UE may receive a control message indicating a set of multiple resources for which the UE may predict interference information. The UE may select a codebook from a set of multiple codebooks to compress the interference information for the set of multiple resources that follows the control message. The UE may select the codebook based on the set of multiple resources associated with the interference information The UE may transmit a report indicating the interference information predictions to a network entity. That is, the report may include the interference information that may be compressed using the selected codebook. The network entity may receive the report and decompress the interference information to retrieve the predicted interference information for a wireless communications system.

### FIELD OF TECHNOLOGY

The following relates to wireless communications, including efficient codebook-based interference prediction reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, inter-cell interference may affect channel conditions and the quality of wireless channels involving multiple cells. In some cases, one or more configuration parameters of neighboring cells may impact the temporal, frequency, and spatial correlation of inter-cell interference. In addition, inter-cell interference may vary over time due to the dynamic environment of a wireless communication system. As such, some wireless communications systems may enable techniques to observe inter-cell interference.

### SUMMARY

The described techniques relate to improved methods, systems, devices, and apparatuses that support codebook-based interference prediction reporting. For example, the described techniques provide for a user equipment (UE) to receive a control message from a network entity that indicates a set of multiple resources for which the UE is to predict interference information. That is, the UE may select a codebook from a set of multiple codebooks that compresses the predicted interference information for the set of multiple of resources based on the control message. The UE may compress the interference information using the codebook selected based on the set of multiple resources associated with the interference information. The UE may transmit a report that indicates the interference information to a network entity. As such, the network entity may decompress the interference information to retrieve the predicted interference information while reducing the reporting overhead of predicted interference.

In other implementations, the network entity may predict interference information for the set of multiple resources. That is, the network entity may select the codebook for compressing the interference information based on the correlation of interference information for the set of multiple resources. The network entity may transmit a report indicating the interference information that is compressed based on the selected codebook. As such, the UE may receive the predicted interference information to allocate suitable resources for reporting interference information or feedback for the one or more channels.

A method for wireless communications at a user equipment (UE) is described. The method may include receiving a control message indicating a set of multiple resources for which the UE is to predict interference information, selecting a codebook from a set of multiple codebooks to compress the interference information based on the set of multiple resources associated with the interference information, and transmitting a report indicating the interference information, where the interference information is compressed using the codebook.

An apparatus for wireless communications at a UE is described. The apparatus may include a processor, memory coupled with the processor, and instructions stored in the memory. The instructions may be executable by the processor to cause the apparatus to receive a control message indicating a set of multiple resources for which the UE is to predict interference information, select a codebook from a set of multiple codebooks to compress the interference information based on the set of multiple resources associated with the interference information, and transmit a report indicating the interference information, where the interference information is compressed using the codebook.

Another apparatus for wireless communications at a UE is described. The apparatus may include means for receiving a control message indicating a set of multiple resources for which the UE is to predict interference information, means for selecting a codebook from a set of multiple codebooks to compress the interference information based on the set of multiple resources associated with the interference information, and means for transmitting a report indicating the interference information, where the interference information is compressed using the codebook.

A non-transitory computer-readable medium storing code for wireless communications at a UE is described. The code may include instructions executable by a processor to receive a control message indicating a set of multiple resources for which the UE is to predict interference information, select a codebook from a set of multiple codebooks to compress the interference information based on the set of multiple resources associated with the interference information, and transmit a report indicating the interference information, where the interference information is compressed using the codebook.

Some examples of the method, apparatuses, and non-transitory computer-readable medium described herein may further include operations, features, means, or instructions for compressing the interference information using the codebook that may be selected based on the set of multiple resources associated with the interference information.

Some examples of the method, apparatuses, and non-transitory computer-readable medium described herein may further include operations, features, means, or instructions for transmitting a capability message indicating a capability of the UE to support using the codebook to compress the interference information and predicting the interference information based on transmitting the capability message.

In some examples of the method, apparatuses, and non-transitory computer-readable medium described herein, the capability message indicates one or more codebook indices corresponding to one or more codebooks that the UE supports for compressing the interference information.

In some examples of the method, apparatuses, and non-transitory computer-readable medium described herein, each codebook of the set of multiple codebooks may be defined based on a correlation between the interference information and a quantity of codewords of the codebook.

In some examples of the method, apparatuses, and non-transitory computer-readable medium described herein, each codebook of the set of multiple codebooks may be associated with a different quantity of resources of the set of multiple resources for which the interference information may be compressed.

In some examples of the method, apparatuses, and non-transitory computer-readable medium described herein, the codebook may be selected based on the set of multiple resources being within a time period.

In some examples of the method, apparatuses, and non-transitory computer-readable medium described herein, the codebook may be selected based on the set of multiple resources being within a range of frequency bands.

In some examples of the method, apparatuses, and non-transitory computer-readable medium described herein, the codebook may be selected based on the set of multiple resources being within a range of beams.

In some examples of the method, apparatuses, and non-transitory computer-readable medium described herein, the codebook may be selected based on a subset of the set of multiple resources being within a time period, a range of frequency bands, a range of beams, or any combination thereof.

Some examples of the method, apparatuses, and non-transitory computer-readable medium described herein may further include operations, features, means, or instructions for transmitting a message recommending the codebook for compressing the interference information based on the interference information, where the control message indicates the recommended codebook.

Some examples of the method, apparatuses, and non-transitory computer-readable medium described herein may further include operations, features, means, or instructions for transmitting a message recommending a minimum separation between a subset of resources of the set of multiple resources, where the subset of resources may be grouped together in a same codeword of the codebook based on the interference information, and where the minimum separation may be in a time domain, a frequency domain, a spatial domain, or any combination thereof and receiving the control message indicating the subset of resources in accordance with the recommended minimum separation.

Some examples of the method, apparatuses, and non-transitory computer-readable medium described herein may further include operations, features, means, or instructions for transmitting a message recommending a subset of resources of the set of multiple resources that may be grouped together in a same codeword of the codebook based on the interference information and receiving the control message indicating the recommended subset of resources.

In some examples of the method, apparatuses, and non-transitory computer-readable medium described herein, a resource of the set of multiple resources may be defined by a time domain parameter, a frequency domain parameter, a spatial domain parameter, or a combination thereof and a subset of codebooks of a set of multiple codebooks may be associated the resource based on one or more of the time domain parameter, the frequency domain parameter, and the spatial domain parameter.

In some examples of the method, apparatuses, and non-transitory computer-readable medium described herein, the codebook may be defined based on a set of environmental conditions and a separation between each resource of the set of multiple resources in a time domain, a frequency domain, a spatial domain, or a combination thereof.

Some examples of the method, apparatuses, and non-transitory computer-readable medium described herein may further include operations, features, means, or instructions for receiving an indication to switch from using the selected codebook to using a different codebook for compressing the interference information.

Some examples of the method, apparatuses, and non-transitory computer-readable medium described herein may further include operations, features, means, or instructions for receiving an indication of a set of codewords for the codebook, where the set of codewords may be based on a set of environmental conditions and a separation between each resource of the set of multiple resources.

A method for wireless communications at a network entity is described. The method may include transmitting a control message indicating a set of multiple resources for which a UE is to predict interference information, transmitting an indication of a set of multiple codebooks for compressing the interference information based on the set of multiple resources associated with the interference information, and receiving a report indicating the interference information, where the interference information is compressed using a codebook of the set of multiple codebooks.

An apparatus for wireless communications at a network entity is described. The apparatus may include a processor, memory coupled with the processor, and instructions stored in the memory. The instructions may be executable by the processor to cause the apparatus to transmit a control message indicating a set of multiple resources for which a UE is to predict interference information, transmit an indication of a set of multiple codebooks for compressing the interference information based on the set of multiple resources associated with the interference information, and receive a report indicating the interference information, where the interference information is compressed using a codebook of the set of multiple codebooks.

Another apparatus for wireless communications at a network entity is described. The apparatus may include means for transmitting a control message indicating a set of multiple resources for which a UE is to predict interference information, means for transmitting an indication of a set of multiple codebooks for compressing the interference information based on the set of multiple resources associated with the interference information, and means for receiving a report indicating the interference information, where the interference information is compressed using a codebook of the set of multiple codebooks.

A non-transitory computer-readable medium storing code for wireless communications at a network entity is described. The code may include instructions executable by a processor to transmit a control message indicating a set of multiple resources for which a UE is to predict interference information, transmit an indication of a set of multiple codebooks for compressing the interference information based on the set of multiple resources associated with the interference information, and receive a report indicating the interference information, where the interference information is compressed using a codebook of the set of multiple codebooks.

Some examples of the method, apparatuses, and non-transitory computer-readable medium described herein may further include operations, features, means, or instructions for receiving a capability message indicating a capability of the UE to support using the codebook to compress the interference information.

In some examples of the method, apparatuses, and non-transitory computer-readable medium described herein, the capability message indicates one or more codebook indices corresponding to one or more codebooks that the UE supports for compressing the interference information.

In some examples of the method, apparatuses, and non-transitory computer-readable medium described herein, each codebook of the set of multiple codebooks may be defined based on a correlation between the interference information and a quantity of codewords of the codebook.

In some examples of the method, apparatuses, and non-transitory computer-readable medium described herein, each codebook of the set of multiple codebooks may be associated with a different quantity of resources of the set of multiple resources for which the interference information may be compressed.

In some examples of the method, apparatuses, and non-transitory computer-readable medium described herein, the codebook may be selected based on the set of multiple resources being within a time period.

In some examples of the method, apparatuses, and non-transitory computer-readable medium described herein, the codebook may be selected based on the set of multiple resources being within a range of frequency bands.

In some examples of the method, apparatuses, and non-transitory computer-readable medium described herein, the codebook may be selected based on the set of multiple resources being within a range of beams.

In some examples of the method, apparatuses, and non-transitory computer-readable medium described herein, the codebook may be selected based on a subset of the set of multiple resources being within a time period, a range of frequency bands, a range of beams, or any combination thereof.

Some examples of the method, apparatuses, and non-transitory computer-readable medium described herein may further include operations, features, means, or instructions for receiving a message recommending the codebook for compressing the interference information based on the interference information, where the control message indicates the recommended codebook.

Some examples of the method, apparatuses, and non-transitory computer-readable medium described herein may further include operations, features, means, or instructions for receiving a message recommending a minimum separation between a subset of resources of the set of multiple resources, where the subset of resources may be grouped together in a same codeword of the codebook based on the interference information, and where the minimum separation may be in a time domain, a frequency domain, a spatial domain, or any combination thereof and transmitting the control message indicating the subset of resources in accordance with the recommended minimum separation.

Some examples of the method, apparatuses, and non-transitory computer-readable medium described herein may further include operations, features, means, or instructions for receiving a message recommending a subset of resources of the set of multiple resources that may be grouped together in a same codeword of the codebook based on the interference information and transmitting the control message indicating the recommended subset of resources.

In some examples of the method, apparatuses, and non-transitory computer-readable medium described herein, a resource of the set of multiple resources may be defined by a time domain parameter, a frequency domain parameter, a spatial domain parameter, or a combination thereof and a subset of codebooks of a set of multiple codebooks may be associated the resource based on one or more of the time domain parameter, the frequency domain parameter, and the spatial domain parameter.

In some examples of the method, apparatuses, and non-transitory computer-readable medium described herein, the codebook may be defined based on a set of environmental conditions and a separation between each resource of the set of multiple resources in a time domain, a frequency domain, a spatial domain, or a combination thereof.

Some examples of the method, apparatuses, and non-transitory computer-readable medium described herein may further include operations, features, means, or instructions for transmitting an indication to switch from using the selected codebook to using a different codebook for compressing the interference information.

Some examples of the method, apparatuses, and non-transitory computer-readable medium described herein may further include operations, features, means, or instructions for transmitting an indication of a set of codewords for the codebook, where the set of codewords may be based on a set of environmental conditions and a separation between each resource of the set of multiple resources.

A method for wireless communications at a network entity is described. The method may include predicting interference information for a set of multiple resources, selecting a codebook from a set of multiple codebooks to compress the interference information based on the set of multiple resources associated with the interference information, and transmitting a report indicating the interference information, where the interference information is compressed using the codebook.

An apparatus for wireless communications at a network entity is described. The apparatus may include a processor, memory coupled with the processor, and instructions stored in the memory. The instructions may be executable by the processor to cause the apparatus to predict interference information for a set of multiple resources, select a codebook from a set of multiple codebooks to compress the interference information based on the set of multiple resources associated with the interference information, and transmit a report indicating the interference information, where the interference information is compressed using the codebook.

Another apparatus for wireless communications at a network entity is described. The apparatus may include means for predicting interference information for a set of multiple resources, means for selecting a codebook from a set of multiple codebooks to compress the interference information based on the set of multiple resources associated with the interference information, and means for transmitting a report indicating the interference information, where the interference information is compressed using the codebook.

A non-transitory computer-readable medium storing code for wireless communications at a network entity is described. The code may include instructions executable by a processor to predict interference information for a set of multiple resources, select a codebook from a set of multiple codebooks to compress the interference information based on the set of multiple resources associated with the interference information, and transmit a report indicating the interference information, where the interference information is compressed using the codebook.

In some examples of the method, apparatuses, and non-transitory computer-readable medium described herein, each codebook of the set of multiple codebooks may be defined based on a correlation between the interference information and a quantity of codewords of the codebook.

In some examples of the method, apparatuses, and non-transitory computer-readable medium described herein, each codebook may be associated with a different quantity of resources of the set of multiple resources for which the interference information may be compressed.

In some examples of the method, apparatuses, and non-transitory computer-readable medium described herein, the codebook may be selected based on the set of multiple resources being within a time period.

In some examples of the method, apparatuses, and non-transitory computer-readable medium described herein, the codebook may be selected based on the set of multiple resources being within a range of frequency bands.

In some examples of the method, apparatuses, and non-transitory computer-readable medium described herein, the codebook may be selected based on the set of multiple resources being within a range of beams.

In some examples of the method, apparatuses, and non-transitory computer-readable medium described herein, the codebook may be selected based on a subset of the set of multiple resources being within a time period, a range of frequency bands, a range of beams, or any combination thereof.

Some examples of the method, apparatuses, and non-transitory computer-readable medium described herein may further include operations, features, means, or instructions for compressing the interference information using the codebook that may be selected based on the set of multiple resources associated with the interference information.

In some examples of the method, apparatuses, and non-transitory computer-readable medium described herein, the codebook may be defined based on a set of environmental conditions and a separation between each resource of the set of multiple resources in a time domain, a frequency domain, a spatial domain, or a combination thereof.

In some examples of the method, apparatuses, and non-transitory computer-readable medium described herein, the set of multiple resources vary in a time domain, a frequency domain, a spatial domain, or a combination thereof.

### BRIEF DESCRIPTION OF THE DRAWINGS

FIG. 1 shows an example of a wireless communications system that supports efficient codebook-based interference prediction reporting in accordance with one or more aspects of the present disclosure.

FIG. 2 shows an example of a wireless communications system that supports efficient codebook-based interference prediction reporting in accordance with one or more aspects of the present disclosure.

FIG. 3 shows an example of a resource selection scheme for a wireless communications system that supports efficient codebook-based interference prediction reporting in accordance with one or more aspects of the present disclosure.

FIGS. 4A and 4B show examples of codebooks that support efficient codebook-based interference prediction reporting in accordance with one or more aspects of the present disclosure.

FIG. 5 shows an example of a process flow that supports efficient codebook-based interference prediction reporting in accordance with one or more aspects of the present disclosure.

FIGS. 6 and 7 show block diagrams of devices that support efficient codebook-based interference prediction reporting in accordance with one or more aspects of the present disclosure.

FIG. 8 shows a block diagram of a communications manager that supports efficient codebook-based interference prediction reporting in accordance with one or more aspects of the present disclosure.

FIG. 9 shows a diagram of a system including a device that supports efficient codebook-based interference prediction reporting in accordance with one or more aspects of the present disclosure.

FIGS. 10 and 11 show block diagrams of devices that support efficient codebook-based interference prediction reporting in accordance with one or more aspects of the present disclosure.

FIG. 12 shows a block diagram of a communications manager that supports efficient codebook-based interference prediction reporting in accordance with one or more aspects of the present disclosure.

FIG. 13 shows a diagram of a system including a device that supports efficient codebook-based interference prediction reporting in accordance with one or more aspects of the present disclosure.

FIGS. 14 through 18 show flowcharts illustrating methods that support efficient codebook-based interference prediction reporting in accordance with one or more aspects of the present disclosure.

### DETAILED DESCRIPTION

Wireless communications systems may suffer from inter-cell interference that affects channel conditions and the quality of wireless channels. In addition, inter-cell interference may vary over time due to the dynamic environment of a wireless communication system. In some cases, one or more configuration parameters of neighboring cells may impact the temporal, frequency, and spatial correlation of inter-cell interference. In some cases, predicting inter-cell interference may enable a network to select suitable parameters for a wireless channel. As such, some wireless communications systems may enable techniques to observe inter-cell interference. For example, some wireless communications systems may enable a user equipment (UE) to observe different inter-cell interference based on parameters of neighboring cells, such as scheduling parameters, resource utilization, and the like. A network may enable the UE to predict and report interference for a large quantity of resources to assist a network entity schedule the UE with suitable resources. However, generating interference predictions for different receive and transmit beams and beam-pairs and predicting interference power on multiple future slots and sub-bands, may result in a high signaling overhead between the UE and the network to communicate those predictions from the UE to the network.

The described techniques relate to improved methods, systems, devices, and apparatuses that support codebook-based interference prediction reporting. In some wireless communications systems, the network may aim to reduce the overhead of generating interference for many different beams and beam combinations. That is, a network entity may configure a UE to compress predicted interference measurements based on the resources associated with the interference measurements being correlated in time, frequency, and space. Further, the network entity may configure the UE with a set of resources for the UE to predict interference information. That is, the UE may predict the interference information, select a codebook out of a set of codebooks to compress the interference information, and transmit a report to the network entity that includes the compressed interference information. In the report, the UE may compress the interference information using a codebook that the UE selects based on the set of resources. In some cases, the UE may select the codebook from a pre-defined set of multiple codebooks or the network entity may indicate possible codebooks that the UE may use. As such, the UE may transmit the report to the network entity, and the network entity may decompress the interference information to retrieve the predicted interference information while reducing the reporting overhead of predicted interference.

Additionally, or alternatively, some wireless communications systems may enable the network entity to predict the interference information and compress the information using codebook-based schemes. For example, the network entity may predict interference information for the set of multiple resources. That is, the network entity may select the codebook for compressing the interference information based on the correlation of interference information for the set of multiple resources. In some examples, the network entity may select the codebook from a pre-defined set of multiple codebooks, or a network (e.g., a core network) may indicate possible codebooks that the network entity may use. The network entity may transmit a report indicating the interference information that is compressed based on the selected codebook. As such, the UE may receive the predicted interference information to allocate suitable resources for reporting interference information or feedback for the one or more channels.

Particular aspects of the subject matter described herein may be implemented to realize one or more potential advantages. The described techniques may provide for reduced signaling overhead between the UE and the network. That is, the network may implement a compression scheme that compresses predicted interference measurements based on a codebook that represents the resources associated with the interference measurements which are correlated in time, frequency, and space. Further, the UE or the network entity may compress and decompress the predicted interference measurements. In some examples, a wireless communications system that uses a codebook-based interference compression may benefit from low complexity, efficient compression, and flexible design. For example, the codebook-based interference compression scheme described herein may lower the complexity and the power consumption for a wireless communication system.

Unlike other compression approaches (e.g., autoencoders), the codebook-based interference compression scheme described herein may include finding a codeword that closely matches a predicted interference sequence for compression and a lookup table that maps the codeword index to the interference codeword for decompression. In other examples, the codebook-based interference compression scheme may increase compression efficiency when there is a high correlation between the interference values in the sequence. In some cases, the compression efficiency may increase as a dimension of the reported interference increases, which may enable interference prediction for a large quantity of resources. In addition, the codebook-based interference compression scheme may result in a flexible design that enables the wireless communication system to change the level of compression based on environment conditions. As such, the wireless communication system may use codebook-based interference compression scheme to reduce overhead from constant signaling.

Aspects of the disclosure are initially described in the context of wireless communications systems. Aspects of the disclosure are then described in the context of resource selection schemes, codebooks, and process flows. Aspects of the disclosure are further illustrated by and described with reference to apparatus diagrams, system diagrams, and flowcharts that relate to codebook-based interference prediction reporting.

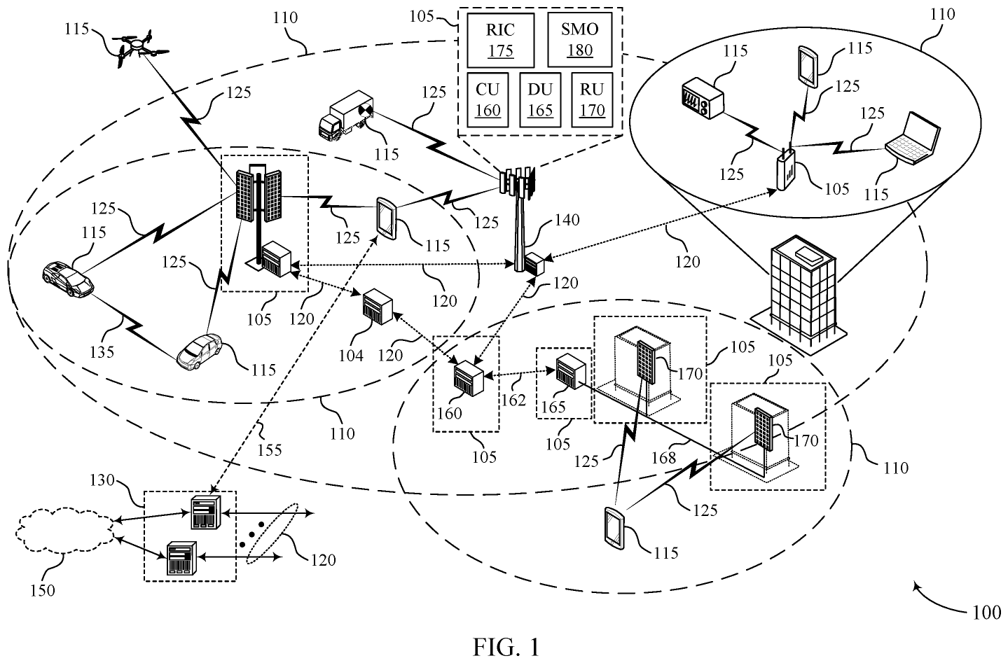

FIG. 1 shows an example of a wireless communications system 100 that supports efficient codebook-based interference prediction reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support efficient codebook-based interference prediction reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a high signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a higher or highest signal strength, higher or highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, the network may aim to reduce the signaling overhead of generating interference for many different beams and beam combinations. That is, a network entity 105 may configure a UE 115 to compress predicted interference measurements based on the resources associated with the interference measurements being correlated in time, frequency, and space. Further, the network entity 105 may configure the UE 115 with a set of resources for the UE 115 to predict interference information. That is, the UE 115 may predict the interference information, select a codebook out of a set of codebooks to compress the interference information, and transmit a report to the network entity 105 that includes the compressed interference information. In the report, the UE 115 may compress the interference information using a codebook that the UE 115 selects based on the set of resources. In some cases, the UE 115 may select the codebook from a pre-defined set of multiple codebooks or a network (e.g., a core network, a network entity 105) may indicate possible codebooks that the UE 115 may use. As such, the UE 115 may transmit the report to the network entity 105, and the network entity 105 may decompress the interference information to retrieve the predicted interference information while reducing the reporting overhead of predicted interference.

Additionally, or alternatively, the wireless communication system 100 may enable the network entity 105 to predict the interference information and compress the information using codebook-based schemes. For example, the network entity 105 may predict interference information for the set of multiple resources. That is, the network entity 105 may select the codebook for compressing the interference information based on the correlation of interference information for the set of multiple resources. In some examples, the network entity 105 may select the codebook from a pre-defined set of multiple codebooks or a network (e.g., a core network) may indicate possible codebooks that the network entity 105 may use. The network entity 105 may transmit a report indicating the interference information that is compressed based on the selected codebook. As such, the UE 115 may receive the predicted interference information to allocate suitable resources for reporting interference information or feedback for the one or more channels.

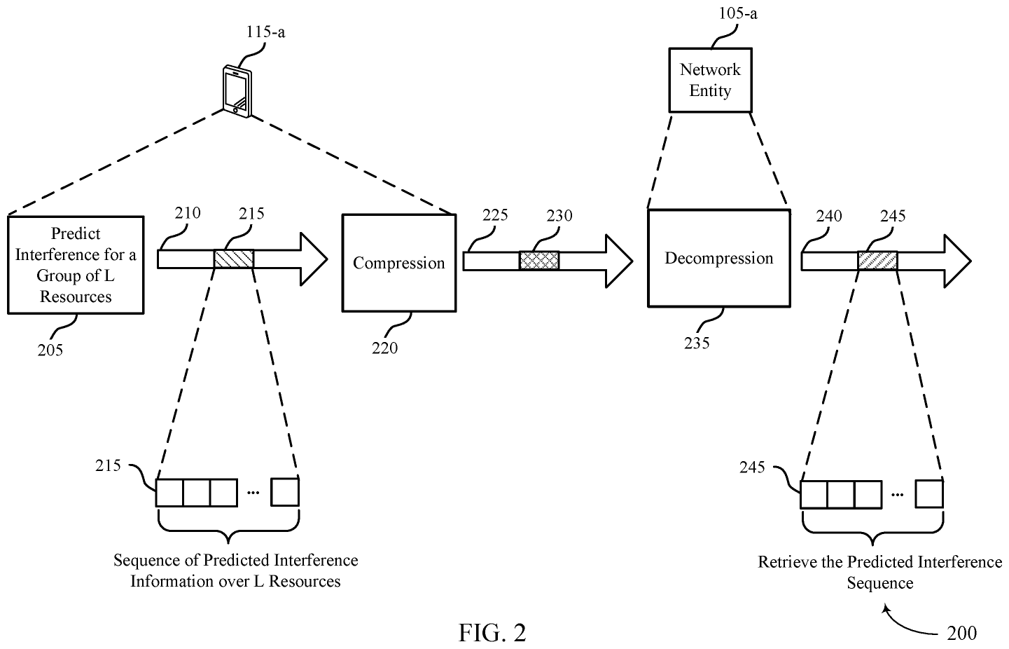

FIG. 2 shows an example of a wireless communications system 200 that supports codebook-based interference prediction reporting in accordance with one or more aspects of the present disclosure. In some examples, the wireless communications system 200 may implement aspects of the wireless communications system 100. The wireless communications system 200 may include a UE 115-a and a network entity 105-a, which may be examples of corresponding devices as described herein, including with reference to FIG. 1.

In some implementations, the wireless communications system 200 may encounter or otherwise experience high signaling overhead between the UE 115-a and the network entity 105-a. In some cases, the wireless communications system 200 may utilize the UE 115-a to report any observed inter-cell interference to the network entity 105-a. In some cases, the UE 115-a may observe different inter-cell interference based on one or more configuration parameters of one or more neighboring cells. For example, the UE 115-a may determine that one or more configuration parameters of the one or more neighboring cells impacts the temporal, frequency, and spatial correlation of inter-cell interference. The UE 115-a may indicate interference predictions to the network entity 105-a to maintain wireless communications between the network devices.

In some examples, some configuration parameters that may impact the temporal correlation of the inter-cell interference may include a scheduling granularity (e.g., mini-slot, slot, multi-slot based, or the like), a subcarrier spacing (SCS), and a type of scheduler (e.g., proportional fair, round robin, or the like). In some cases, correlation plots may represent the temporal interference correlation. For example, a correlation plot may include interference correlation for different file sizes, arrival rates, and resource utilizations (RUs) at the interfering cells that applies a correlation approach. In some cases, the wireless communications system 200 may observe an intra-burst interference power correlation, where the duration of the burst is directly proportional to interference file sizes. In other examples, the wireless communications system 200 may observe high auto-correlation in interference power at low, medium, and high RUS. However, at specific RUs, such as at high RUs, the interference power correlation may drop.

In other implementations, some configuration parameters that may impact the spatial sparsity and rank of the interference may include a loading utilization, a resource utilization, a quantity of active UEs 115, a quantity of active beams, a quantity of TCI states, an elevation of the active beams, and an azimuth angle of the active beams. In other examples, some configuration parameters that may impact periodic interference may include the SCS, configuration grants (CGs), and periodic reference signal transmission configurations. As such, the UE 115-a may observe the inter-cell interference caused by various configuration parameters at neighboring cells.

In some cases, the wireless communications system 200 may support wireless devices, such as the UE 115-a and the network entity 105-a, that may use or otherwise employ interference prediction algorithms. For example, the UE 115-a or the network entity 105-a may observe interference patterns and predict interference on future resources to enable scheduling strategies. In some cases, if the wireless devices (including the UE 115-a, the network entity 105-a, or both) expect the future resources to be of high interference, the wireless devices may exclude those resources from the resource allocation. Alternatively, the wireless devices may determine that suitable resources (e.g., usable resources, not excluded resources) may adapt the rank, modulation coding scheme (MCS), and future reference signals based on the interference predictions. In other cases, the wireless devices may estimate the time or frequency correlation of the interference to be used in demodulation of the suitable resources.

In some examples, the wireless communications system 200 may benefit from using an artificial intelligence (AI) or machine learning (ML) approach for interference prediction algorithms due to the dynamic environment of the wireless communications system 200. That is, many different factors may affect the interference patterns observed in the wireless communications system 200. For example, the UE 115-a may observe varying interference patterns that may make it difficult for an analytical model to represent an interference prediction. As such, an AI or ML model used for interference prediction may learn various interference patterns from previous resources to enable accurate interference predictions for the future resources.

In particular, the wireless communications system 200 may integrate the ML or AI-based model to output probabilistic interference predictions. That is, the ML or AI-based model may quantize the interference and noise power (e.g., I) into ordered classes (e.g., L) with a step (e.g., q) in decibel milliwatts (dBm) starting from a start point (e.g., s) in dBm and ending at an end point (e.g., e) in dBm. For example, the ML or AI-based model may indicate that the step is q=1 dBm, the start point is s=−84 dBm, and the end point is e=−60 dBm. As such, the ML or AI-based model may output 26 interference power classes.

Further, the ML or AI-based model may include a scheme (e.g., a compression scheme) for the AI-based probabilistic interference prediction. That is, the probabilistic interference prediction may account for the statistical behavior of the interference and to obtain the confidence level in the predicted interference. In some examples, the probabilistic approach may include a softmax layer at the end of the model that produces probabilities (e.g., L) for the interference power to be arranged into classes (e.g., L). In such cases, the classes may be organized in a natural order, where the output probabilities represent a distribution for the interference. As such, the ML or AI-based model may input observed interference from previous slots to be run through a softmax layer in order to produce probabilities for interference power that fall in classes. Additionally, the probabilistic ML model outperforms one or more competitive baselines in terms of accuracy (e.g., top-k) of the predicted interference power classes, which may benefit the wireless communications system 200.

In addition, the ML or AI-based model may include the scheme for the AI-based probabilistic interference prediction that uses a neural network architecture for interference prediction on multiple future resources (e.g., slots). That is, the neural network may output branches, where each output branch may be utilized to output probabilistic interference power prediction on a specific future resource. In such cases, each of the output branches may be input into the softmax layer to produce the predicted interference power distribution for each of the future slots. That is, the ML or AI-based model may generate a high confidence and low precision interference power prediction. For example, the probabilistic interference prediction using the ML design or AI-based model may output a predicted interference value and a distribution for the interference prediction. As a result, the output from the ML or AI model, such as the predicted interference value and the distribution, may be used to output the level of confidence for the prediction. In some cases, when the ML or AI model is confident in the prediction, the UE 115-a and the network entity 105-a may observe a higher achieved accuracy in performance and compare an average precision versus target confidence. That is, the UE 115-a and the network entity 105-a may utilize the ML or AI-based model to introduce flexibility to predict interference with various precisions to meet different requirements.

In some aspects, the wireless communications system 200 may experience inter-cell interference and one or more network devices, such as the UE 115-a, may predict and report the interference on a large quantity of resources for the network entity 105-a to schedule resources. For example, the network entity 105-a may request the UE 115-a to assist in reporting the predicted interference over multiple resources such that the network entity 105-a may allocate the UE 115-a with suitable resources. The UE 115-a may generate a set of interference predictions for different receive beams or different transmit and receive beam pairs to assist the network entity 105-a in scheduling the UE 115-a with an appropriate beam. That is, for each interference prediction conditioned for a specific beam or a beam pair, the UE 115-a may predict the interference power for multiple future slots and sub-bands. However, if the UE 115-a were to report each of the interference power predictions, the UE 115-a and the network entity 105-a may encounter high signaling overhead. That is, constant signaling between the UE 115-a and the network entity 105-a may overload the wireless communications system 200 and, as such, methods to avoid high overhead may be desired.

In some implementations, the wireless communications system 200 may support communications between wireless devices, such as the UE 115-a and the network entity 105-a, which may compress predicted interference measurements and reduce signaling overhead for the wireless communications system 200. In some examples, the network entity 105-a may transmit a control message indicating a set of multiple resources for which the UE 115-a may predict and report interference information. For example, the network entity 105-a may configure the UE 115-a to observe interference information for the set of multiple resources that may be correlated in time, frequency, and space. In some cases, the UE 115-a may measure reference signals (e.g., channel state information-reference signal (CSI-RS))) and predict the interference (e.g., perform CSI-interference measurement (CSI-IM)) on a set of future resources based on the configuration indicated from the network entity 105-a. That is, the UE 115-a may receive the control message and select a codebook from a set of multiple codebooks and use the codebook to compress the interference information based on the set of multiple resources associated with the interference information.

In the example of FIG. 2, at 205, the UE 115-a may predict interference information for a set (e.g., group) of L resources indicated in the control message, and select an appropriate codebook to represent and compress the predicted interference information. At 210, the UE 115-a may use the set of L resources and generate a sequence 215 of the predicted interference information over L resources. That is, the UE 115-a may represent a sequence of predicted interference information over the set of L resources and may group the predicted interference on resources closer to each other in time, frequency, or space. In some cases, the sequence of predicted interference information may be associated with an interference power, a recurrent neural network (RNN), a signal interference-to-noise ratio (SINR), or the like. As such, the wireless communications system 200 may utilize non-analytical methods to predict interference information.

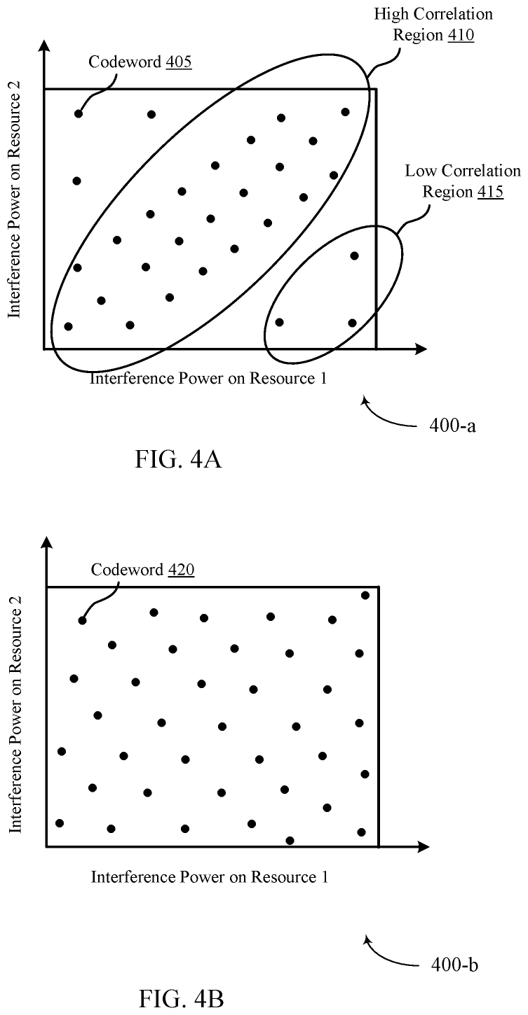

In some implementations, the UE 115-a may use a ML or AI-based model that inputs interference information for the set of L resources to find suitable codewords for the set of L resources. Further, each of the codewords for the set of L resources may be indicated with an index that represents the corresponding interference information. At 220, the UE 115-a may compress the sequence 215 using a codebook that is selected based on the set of multiple resources associated with the interference information. In some examples, the UE 115-a may select the codebook based on a correlation between the interference information and a quantity of codewords of the codebook. That is, instead of the UE 115-a reporting predicted interference information for each of the resources, the UE 115-a may map the interference information to codewords and select a suitable codebook that represents the resources in order to reduce the overhead for the wireless communications system 200. As described herein, the description of FIGS. 4A and 4B provide examples of codebooks that may be selected for compressed interference reporting.

Upon compressing the interference information, at 225, the UE 115-a may transmit a report 230 over the air that indicates the interference information. In some cases, the report 230 may include the codeword index that maps the interference information into codewords of the codebook for the network entity 105-a to use. At 235, the network entity 105-a may decompress the report 230. At 240, the network entity 105-a may output a retrieved predicted interference sequence 245 (that is based on decompressing the report 230) indicating the predicted interference information. As a result, the UE 115-a and the network entity 105-a may reduce signaling overhead while predicting the interference information effectively.

In this way, the wireless communications system 200 may support techniques for unconstrained interference prediction and codebook-based compression. That is, the UE 115-a and the network entity 105-a may utilize a ML model to predict unconstrained interference predictions that may represent any quantized value. In response to the ML model predicting the interference information, the selected codebook may quantize the interference information into one of the available codewords and compress the predicted interference information. As such, the wireless communications system 200 may benefit from the flexibility of switching between different interference compression codebooks without retraining the ML model.

Additionally, or alternatively, the wireless communications system 200 may employ a codebook-aware interference prediction technique, where the ML model may be constrained to predict the interference information within the codewords of the codebook. For example, the UE 115-a may efficiently observe interference measurements, apply the codebook-aware interference prediction, and compress the predicted interference information to reduce the overhead of the wireless communications system 200 and reduce computational resource consumption.

As described herein, the wireless communications system 200 may use codebook-based interference prediction reporting in various ways. In some examples, multiple interference information codebooks may be pre-defined for selection by the UE 115-a or the network entity 105-a. In some cases, each interference information codebook may be associated with a different quantity of resources of the set of multiple resources for which the interference information may be compressed. As a result, the network entity 105-a may determine the resources for which interference information may be desired and may select a codebook to use for the predicted interference from the possible multiple interference information prediction codebooks that are pre-defined.

Additionally, or alternatively, the UE 115-a may predict interference information for the group of L resources and select a codebook depending on the mapping of codewords that represent the resources. As such, the UE 115-a may select a codebook from the set of pre-defined (and stored) codebooks to use for predicting interference associated with the group of L resources based on a correlation between the interference information and a quantity of codewords of the selected codebook. For example, if the interference is highly correlated (e.g., between two resources), the network entity 105-a may select a codebook with codewords concentrated around high-interference correlation regions. Alternatively, the network entity 105-a may select a more balanced codebook based on the interference being relatively equal across all correlation areas. As described herein, the description of FIGS. 4A and 4B may illustrate examples of such codebook types that may be selected for compressed interference reporting.

Additionally, or alternatively, the set of pre-defined codebooks may each be associated with a different dimension (e.g., quantity of reported interference resources). In such cases, the network entity 105-a may select or configure a codebook for use in the interference information reporting based on environmental conditions of the wireless communications system 200 and reported interference predictions made for a quantity of resources. In some examples, the network entity 105-a may configure the codebook used in the predicted interference reporting based on how far the reported interference information is separated in time, frequency, and space. In some other cases, the network entity 105-a may consider the dynamic environment of the wireless communications system 200 and may configure the UE 115-a to switch between different codebooks as the environment changes. As such, the network entity 105-a may utilize the pre-defined codebooks and may configure a codebook based on which of the pre-defined codebooks are available to use for the prediction interference reporting.

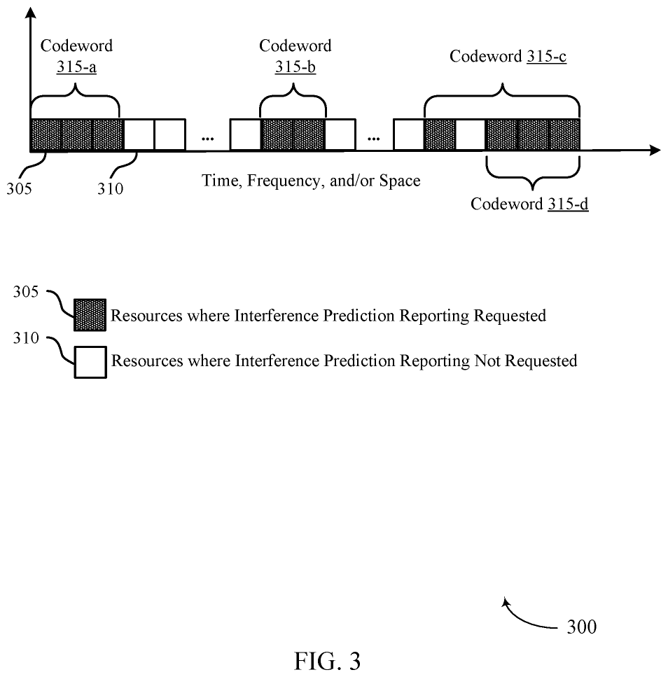

In other examples, the wireless communications system 200 may implement a resource selection process for codebook-based interference information compression. That is, the network entity 105-a may configure the resources used in the codebook-based interference reporting. For example, the network entity 105-a may configure the set (e.g., group) of L resources for which the UE 115-a may predict interference information and report the interference information via the codebook-based interference reporting techniques described herein. In some cases, the set of L resources may vary in space (e.g., different beams), time (e.g., different slots), or frequency (e.g., different sub-bands). That is, the network entity 105-a may configure a minimum resource separation in a time domain, a frequency domain, a spatial domain, or any combination thereof for the predicted resources to be grouped into one single codeword. In some examples, the UE 115-a may observe a high interference correlation for the reported resources when the resources are close in time, frequency, and space. As such, the network entity 105-a may use a more efficient codebook to represent and compress the predicted interference information. As described herein, the description of FIG. 3 illustrates examples of such codebook types that may be selected for compressed interference reporting.

In other aspects, the network entity 105-a may use a set of rules to select a codebook for interference reporting, where the set of rules may be defined based on a separation between predicted interference resources in time, frequency, space, or a combination thereof. That is, some rules (which may be pre-defined for or indicated to the network entity 105-a) may indicate which codebook to select for the interference reporting. For example, if the set of L resources is within a specific time window (e.g., within a quantity of slots or milliseconds (ms)) the network entity 105-a may use a sparser codebook. As described herein, a sparse codebook may describe a codebook that includes relatively evenly-distributed codewords. In another example, if the set of L resources is within a specific band range (e.g., within a quantity of resource blocks (RBs) or a kilohertz (kHz) range), the network entity 105-a may use a sparser codebook. Additionally, or alternatively, if the set of L resources is within a specific beam range, the network entity 105-a may use a sparser codebook. In other aspects, if a quantity of selected resources (e.g., M) is less than or equal to a quantity of resources in the set of L resources and is within a specific time window, beam range, frequency range, or any combination thereof, the network entity 105-a may use a sparser codebook. Alternatively, if the quantity of selected resources (e.g., M, a subset of L) is greater than or equal to the quantity of resources in the set of L resources and is not within a specific time window, beam range, frequency range, or any combination thereof, the network entity 105-a may use a denser codebook. As described herein, a dense codebook may describe a codebook that includes relatively less evenly-distributed codewords (e.g., clustered around particular resources). As such, the UE 115-a or the network entity 105-a may select a codebook for interference reporting based on the resource separation and the pre-defined set of rules as described herein.

Additionally, or alternatively, the network entity 105-a may use a set of rules to generate a codebook for interference reporting, where the set of rules may be defined based on a separation between predicted interference resources in time, frequency, space, or a combination thereof. That is, some rules (which may be pre-defined for or indicated to the network entity 105-a) may indicate how to generate a codebook for the interference reporting. For example, based on data or information such as the time, frequency, or spatial separation between predicted interference resources), the set of rules may indicate which compression algorithm or other model to use for generating the codebook based on the data or other information provided. Thus, the network entity 105-a may utilize the algorithm or model to generate a codebook for interference reporting based on the separation between the predicted interference resources in time, frequency, space, or a combination thereof.

In some examples, if the set of L resources is within a specific time window (e.g., within a quantity of slots or milliseconds (ms)) the network entity 105-a may generate and use a sparser codebook. In another example, if the set of L resources is within a specific band range (e.g., within a quantity of resource blocks (RBs) or a kilohertz (kHz) range), the network entity 105-a may generate and use a sparser codebook. Additionally, or alternatively, if the set of L resources is within a specific beam range, the network entity 105-a may generate and use a sparser codebook. In other aspects, if a quantity of selected resources (e.g., M) is less than or equal to a quantity of resources in the set of L resources and is within a specific time window, beam range, frequency range, or any combination thereof, the network entity 105-a may generate and use a sparser codebook. Alternatively, if the quantity of selected resources (e.g., M, a subset of L) is greater than or equal to the quantity of resources in the set of L resources and is not within a specific time window, beam range, frequency range, or any combination thereof, the network entity 105-a may generate and use a denser codebook.

In other implementations, the wireless communications system 200 may enable the network entity 105-a to configure the codewords of a selected codebook. That is, depending on the environment conditions of the wireless communications system 200 and the separation between resources, the network entity 105-a may configure the codewords of the codebook and notify the UE 115-a to ensure efficient interference reporting.

Additionally, or alternatively, the wireless communications system 200 may enable the network entity 105-a to configure the codebook for the predicted interference compression. As described herein, the network entity 105-a may utilize the same methods as the UE 115-a as described herein. That is, the network entity 105-a may configure and deploy the codebook-based interference prediction reporting instead of the UE 115-a. In such cases, the wireless communications system 200 may enable the network entity 105-a to configure the codebook to reduce the complexity and power consumption of resources at the UE 115-a. The network entity 105-a may compress the interference measurements using codebook-based schemes and indicate the interference measurements to the UE 115-a. As such, the UE 115-a may use the interference measurements to report a channel state feedback (CSF) report.

In other examples, the wireless communications system 200 may enable the UE 115-a to transmit a capability message (e.g., report) for interference compression reporting using codebook-based schemes. That is, the UE 115-a may transmit a capability message indicating whether the UE 115-a supports codebook-based interference prediction reporting. In addition, the UE 115-a may report the codebook indices it may support for the compressed interference reporting, in which multiple codebooks may be pre-defined for the UE 115-a. As such, the UE 115-a may transmit the capability message to provide interference compression reporting for the wireless communications system 200.

In some cases, the UE 115-a may provide recommendations for one or more parameters of the interference compression reporting. In some examples, the UE 115-a may transmit a message that recommends to use a specific codebook for the interference compression based on observed interference measurements of predictions. In other examples, the UE 115-a may recommend the minimum resource separation in time, frequency, space (e.g., beams), or a combination thereof for specific resources to be grouped together in a single codeword. In such cases, the UE 115-a may determine the minimum resource separation based on observing the interference patterns. Additionally, the UE 115-a may recommend to group specific resources in a single codeword of a codebook based on observing the interference patterns. As a result, the network entity 105-a may transmit the control message that indicates the recommended codebook, the subset of resources that follows the recommended minimum resource separation, the recommended subset of resources for grouping codewords, or a combination thereof. That is, the wireless communications system 200 may employ various techniques to reduce the reporting overhead of the explicit predicted interference and provide an efficient way to report predicted interference information.

FIG. 3 shows an example of a resource selection scheme 300 for a wireless communications system that supports codebook-based interference prediction reporting in accordance with one or more aspects of the present disclosure. In some examples, the resource selection scheme 300 may be implemented into the wireless communications system 100 and 200. The resource selection scheme 300 may be implemented by UEs 115 and network entities 105, which may be examples of corresponding devices as described herein, including with reference to FIGS. 1 and 2.

In some implementations, a wireless communications system may implement the resource selection scheme 300, which includes a process for codebook-based interference information compression. In some cases, a network entity 105 may configure a UE 115 with resources for which to perform codebook-based interference reporting. For example, the network entity 105 may configure the UE 115 with a set (e.g., group) of L resources, for which the UE 115 may predict interference information and report the interference information using the codebook-based interference reporting techniques described herein.

In some cases, the set of L resources may vary in space (e.g., beams), time (e.g., slots), frequency (e.g., sub-bands), or a combination thereof. That is, the network entity 105 may configure a minimum resource separation in time, frequency, space, or a combination thereof for the predicted resources to be grouped into one single codeword. For example, the network entity 105 may group resources (e.g., define a subset of resources) into single codewords based on the indicated resource separations. In the example of FIG. 3, out of the set of L resources, the network entity 105 may group resources 305, for which interference prediction reporting is requested, together and indicate resources 310, for which interference prediction reporting is not requested. That is, the network entity 105 may determine, based on the resource separation and correlations between the resources for the set of L resources, that resources may be grouped into single codewords 315. As such, the network entity 105 may group the predicted interference on resources closer to each other in either time, frequency, or space into single codewords 315. In this example, the network entity 105 may determine a codeword 315-a, a codeword 315-b, a codeword 315-c, and a codeword 315-d. Hence, the wireless communications system may implement resource selection for codebook-based interference information compression to reduce overhead and increase efficiency for interference reporting.

FIG. 4A shows an example of a codebook 400-a that supports codebook-based interference prediction reporting in accordance with one or more aspects of the present disclosure. In some examples, the codebook 400-a may implement aspects of the wireless communications system 100 and 200. The codebook 400-a may be selected and implemented by a network entity 105 and a UE 115, which may be examples of corresponding devices as described herein, including with reference to FIGS. 1 and 2.

In some examples, multiple interference information codebooks may be pre-defined for the network entity 105 and the UE 115. That is, the network entity 105 or the UE 115 may select one or more codebooks to use for the predicted interference from the multiple codebooks pre-defined. In some examples, the network entity 105 may indicate, via a control message, which of the group of L resources for which to predict interference information. The UE 115 may predict interference information for the group of L resources and apply a codebook depending on a mapping of codewords that represents the resources. That is, the UE 115 may select a codebook from the pre-defined and available codebooks to use for predicting interference that represents the group of L resources.

In the example of FIG. 4A, the codebook 400-a may be associated with a quantity of resources (e.g., L) and corresponding interference power. That is, the codebook 400-a may include multiple codewords 405 representing resources where an x-axis demonstrates the interference power on resource 1 and a y-axis demonstrates the interference power on resource 2. In this example, the codebook 400-a may be designed for a pair of resources (e.g., L=2 corresponding to resource 1 and resource 2). However, the codebook 400-a may not be limited to 2 resources and the network entity 105 may indicate any quantity of resources for which the UE 115 is to predict interference information. That is, the codebook 400-a may be generalized to include higher dimensions (e.g., L>2). Further, if the dimension of the codebook 400-a increases, a compression efficiency associated with the codebook 400-a may increase additionally.

In particular, FIG. 4A may illustrate the codebook 400-a with a high correlation region 410 (e.g., a high correlation interference environment), where a large quantity of codewords 405 are focused in one correlation area and a low correlation region 415, where a small quantity of codewords 405 are dispersed away from the high correlation region 410. As such, the codebook 400-a may illustrate an example of a relatively denser codebook, where codewords 405 are concentrated around specific regions. In some aspects, the codebook 400-a may indicate fewer codewords 405 around the low correlation region 415 which may enable the UE 115 or the network entity 105 to compress the reported interference information when a high interference correlation is expected due to the large quantity of codewords 405 at the high correlation region 410. As such, in the wireless communications system, network devices may specify the codebook 400-a and may compress the interference information to reduce overhead signaling.

FIG. 4B illustrates an example of a codebook 400-b that supports codebook-based interference prediction reporting in accordance with one or more aspects of the present disclosure. In some examples, the codebook 400-b may implement aspects of the wireless communications system 100 and 200. The codebook 400-b may be selected and implemented by a network entity 105 and a UE 115, which may be examples of corresponding devices as described herein, including with reference to FIGS. 1 and 2.

As described herein, multiple interference information codebooks may be pre-defined for the network entity 105 and the UE 115. That is, the network entity 105 or the UE 115 may predict interference information using a codebook-based interference prediction reporting approach. In this example, the codebook 400-b a may be associated with a quantity of resources (e.g., L) and corresponding interference power. That is, the codebook 400-b may include multiple codewords 420 representing resources where an x-axis demonstrates the interference power on resource 1 and a y-axis demonstrates the interference power on resource 2. In this example, the codebook 400-b may be designed for a pair of resources (e.g., L=2 corresponding to resource 1 and resource 2). However, the codebook 400-b may not be limited to 2 resources and the network entity 105 may indicate any quantity of resources for which the UE 115 is to predict interference information. That is, the codebook 400-b may be generalized to include higher dimensions (e.g., L>2). Further, if the dimension of the codebook 400-b increases, the compression efficiency associated with the codebook 400-b may increase additionally.

In particular, FIG. 4B may illustrate the codebook 400-a as a relatively balanced codebook that may be indicative of a low interference correlation between the two resources. That is, the codebook 400-b may illustrate multiple codewords 420 that are evenly spaced, where one or more correlation regions are not apparent and therefore a high interference correlation region may not exist. As such, the codebook 400-b may illustrate a balanced codebook that quantizes the interference equally across all interference correlation areas and may also be applied to compress the interference information for the wireless communications system.

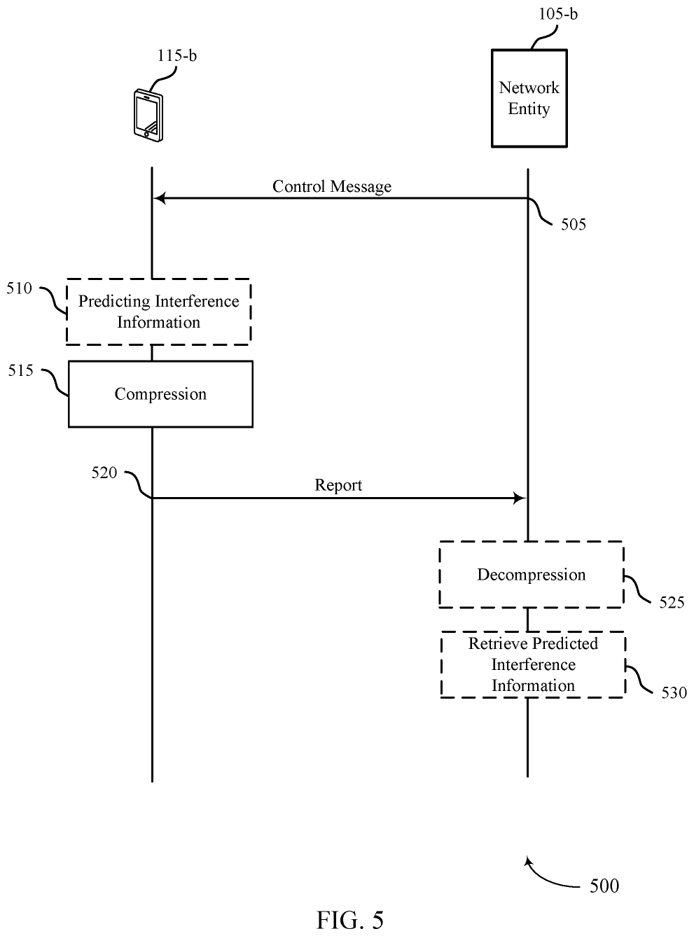

FIG. 5 shows an example of a process flow 500 that supports codebook-based interference prediction reporting in accordance with one or more aspects of the present disclosure. In some examples, the process flow 500 may implement aspects of the wireless communications systems 100 and 200 and implement features from the resource selection scheme 300, the codebook 400-a, and the codebook 400-b. The process flow 500 may include a UE 115-b and a network entity 105-b, which may be examples of corresponding devices as described herein, including with reference to FIGS. 1 and 2.

At 505, the network entity 105-b may transmit a control message indicating a set of multiple resources for which the UE 115-b may predict interference information. In some examples, the control message may indicate a recommended codebook that the UE 115-b may use to predict interference information. In other cases, the control message may indicate a subset of resources that follows a recommended minimum resource separation.

At 510, the UE 115-b may predict interference information for the set of multiple resources based on the indication in the control message. In some examples, the UE 115-b may predict the interference information based on whether the UE 115-b may support a selected codebook indicated in the control message.

At 515, the UE 115-b may compress the predicted interference information using a codebook selected based on the set of multiple resources associated with the interference information. In some examples, the codebook may include one or more codewords that represents the set of multiple resources selected to predict interference information. Further, either the UE 115-b or the network entity 105-b may select the codebook that represents the predicted interference information based on the set of multiple resources being either within a time period, a range of frequency bands, a range of beams, or a combination of these parameters. In some cases, the network entity 105-b may pre-select the codebook for the UE 115-b to use based on the environment of the wireless communications system or previous resources. In such examples, the UE 115-b may determine the codebook and may compress the predicted interference information using a compression scheme based on a correlation between the interference information and a quantity of the codewords of the codebook.

At 520, the UE 115-b may transmit a report that indicates the interference information. The interference information may be compressed via the selected codebook based on the set of multiple resources associated with the interference information. In some examples, the UE 115-b may transmit the report to reduce overhead for the wireless communications system and may efficiently transmit predicted interference information to the network entity 105-b.

At 525, the network entity 105-b may decompress the predicted interference information from the UE 115-b. In some examples, decompression may include using a lookup table that maps the codeword index to the interference codeword for the codebook.

At 530, the network entity 105-b may retrieve the predicted interference information. That is, the network entity 105-b may decompress the codewords to retrieve the predicted interference information for the set of multiple resources. As such, the wireless communications system may use this approach of a codebook-based prediction reporting which may be less complex, more efficient, and more flexible than other compression approaches.

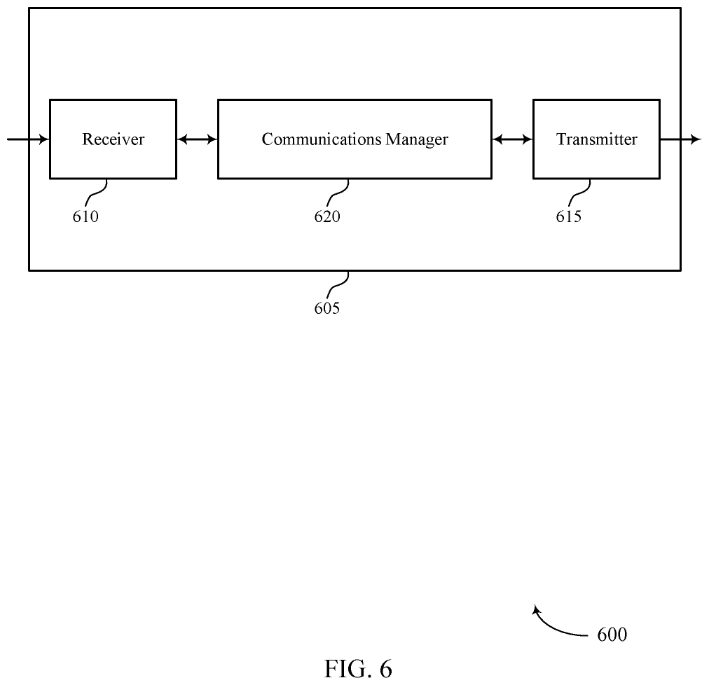

FIG. 6 shows a block diagram 600 of a device 605 that supports efficient codebook-based interference prediction reporting in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to efficient codebook-based interference prediction reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to efficient codebook-based interference prediction reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of efficient codebook-based interference prediction reporting as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 is capable of, configured to, or operable to support a means for receiving a control message indicating a set of multiple resources for which the UE is to predict interference information. The communications manager 620 is capable of, configured to, or operable to support a means for selecting a codebook from a set of multiple codebooks to compress the interference information based on the set of multiple resources associated with the interference information. The communications manager 620 is capable of, configured to, or operable to support a means for transmitting a report indicating the interference information, where the interference information is compressed using the codebook.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reducing signaling overhead between one or more UEs and one or more network entities. That is, network devices, such as the device 605 may implement compression schemes that may lower the complexity and power consumption for a wireless communication system.

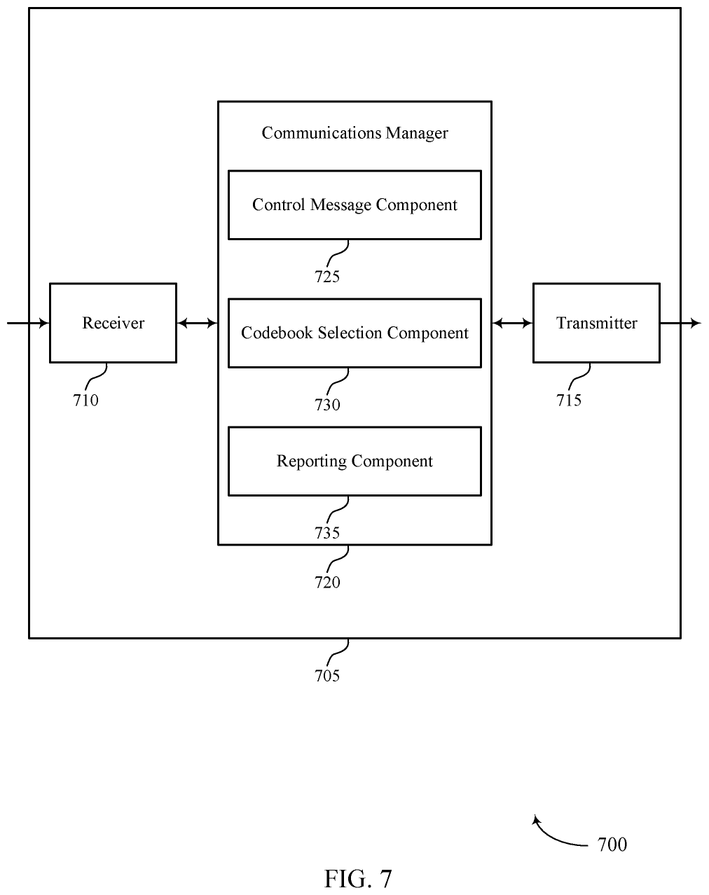

FIG. 7 shows a block diagram 700 of a device 705 that supports efficient codebook-based interference prediction reporting in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to efficient codebook-based interference prediction reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to efficient codebook-based interference prediction reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of efficient codebook-based interference prediction reporting as described herein. For example, the communications manager 720 may include a control message component 725, a codebook selection component 730, a reporting component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The control message component 725 is capable of, configured to, or operable to support a means for receiving a control message indicating a set of multiple resources for which the UE is to predict interference information. The codebook selection component 730 is capable of, configured to, or operable to support a means for selecting a codebook from a set of multiple codebooks to compress the interference information based on the set of multiple resources associated with the interference information. The reporting component 735 is capable of, configured to, or operable to support a means for transmitting a report indicating the interference information, where the interference information is compressed using the codebook.

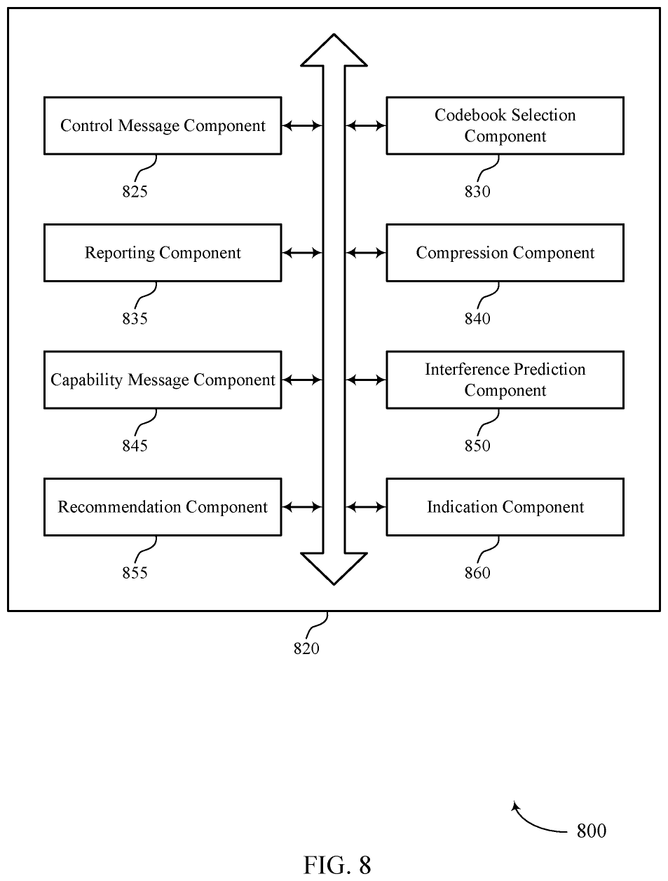

FIG. 8 shows a block diagram 800 of a communications manager 820 that supports efficient codebook-based interference prediction reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of efficient codebook-based interference prediction reporting as described herein. For example, the communications manager 820 may include a control message component 825, a codebook selection component 830, a reporting component 835, a compression component 840, a capability message component 845, an interference prediction component 850, a recommendation component 855, an indication component 860, or any combination thereof. Each of these components may communicate, directly or indirectly, with one another (e.g., via one or more buses).

The communications manager 820 may support wireless communications at a UE in accordance with examples as disclosed herein. The control message component 825 is capable of, configured to, or operable to support a means for receiving a control message indicating a set of multiple resources for which the UE is to predict interference information. The codebook selection component 830 is capable of, configured to, or operable to support a means for selecting a codebook from a set of multiple codebooks to compress the interference information based on the set of multiple resources associated with the interference information. The reporting component 835 is capable of, configured to, or operable to support a means for transmitting a report indicating the interference information, where the interference information is compressed using the codebook.

In some examples, the compression component 840 is capable of, configured to, or operable to support a means for compressing the interference information using the codebook that is selected based on the set of multiple resources associated with the interference information.

In some examples, the capability message component 845 is capable of, configured to, or operable to support a means for transmitting a capability message indicating a capability of the UE to support using the codebook to compress the interference information. In some examples, the interference prediction component 850 is capable of, configured to, or operable to support a means for predicting the interference information based on transmitting the capability message.

In some examples, the capability message indicates one or more codebook indices corresponding to one or more codebooks that the UE supports for compressing the interference information.

In some examples, each codebook of the set of multiple codebooks is defined based on a correlation between the interference information and a quantity of codewords of the codebook.

In some examples, each codebook of the set of multiple codebooks is associated with a different quantity of resources of the set of multiple resources for which the interference information is compressed.

In some examples, the codebook is selected based on the set of multiple resources being within a time period. In some examples, the codebook is selected based on the set of multiple resources being within a range of frequency bands.

In some examples, the codebook is selected based on the set of multiple resources being within a range of beams. In some examples, the codebook is selected based on a subset of the set of multiple resources being within a time period, a range of frequency bands, a range of beams, or any combination thereof.

In some examples, the recommendation component 855 is capable of, configured to, or operable to support a means for transmitting a message recommending the codebook for compressing the interference information based on the interference information, where the control message indicates the recommended codebook.

In some examples, the recommendation component 855 is capable of, configured to, or operable to support a means for transmitting a message recommending a minimum separation between a subset of resources of the set of multiple resources, where the subset of resources are to be grouped together in a same codeword of the codebook based on the interference information, and where the minimum separation is in a time domain, a frequency domain, a spatial domain, or any combination thereof. In some examples, the control message component 825 is capable of, configured to, or operable to support a means for receiving the control message indicating the subset of resources in accordance with the recommended minimum separation.

In some examples, the recommendation component 855 is capable of, configured to, or operable to support a means for transmitting a message recommending a subset of resources of the set of multiple resources that are to be grouped together in a same codeword of the codebook based on the interference information. In some examples, the control message component 825 is capable of, configured to, or operable to support a means for receiving the control message indicating the recommended subset of resources.

In some examples, a resource of the set of multiple resources is defined by a time domain parameter, a frequency domain parameter, a spatial domain parameter, or a combination thereof. In some examples, a subset of codebooks of the set of multiple codebooks are associated the resource based on one or more of the time domain parameter, the frequency domain parameter, and the spatial domain parameter.

In some examples, the codebook is defined based on a set of environmental conditions and a separation between each resource of the set of multiple resources in a time domain, a frequency domain, a spatial domain, or a combination thereof.

In some examples, the indication component 860 is capable of, configured to, or operable to support a means for receiving an indication to switch from using the selected codebook to using a different codebook for compressing the interference information.

In some examples, the indication component 860 is capable of, configured to, or operable to support a means for receiving an indication of a set of codewords for the codebook, where the set of codewords are based on a set of environmental conditions and a separation between each resource of the set of multiple resources.

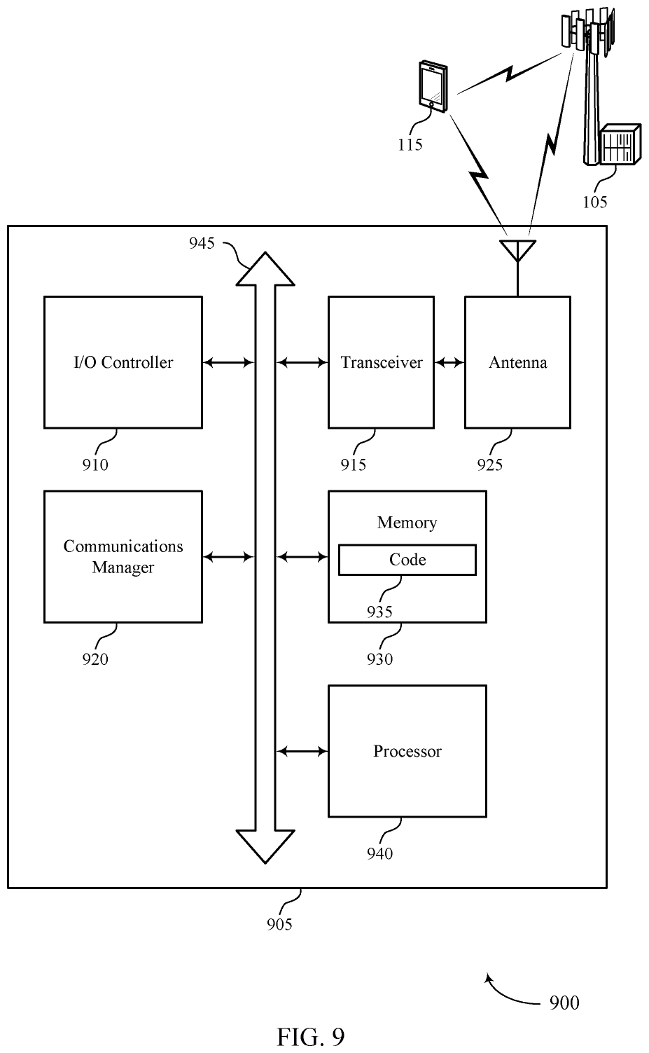

FIG. 9 shows a diagram of a system 900 including a device 905 that supports efficient codebook-based interference prediction reporting in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting efficient codebook-based interference prediction reporting). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 is capable of, configured to, or operable to support a means for receiving a control message indicating a set of multiple resources for which the UE is to predict interference information. The communications manager 920 is capable of, configured to, or operable to support a means for selecting a codebook from a set of multiple codebooks to compress the interference information based on the set of multiple resources associated with the interference information. The communications manager 920 is capable of, configured to, or operable to support a means for transmitting a report indicating the interference information, where the interference information is compressed using the codebook.

By including or configuring the communications manager 920 in accordance with examples as described herein, the device 905 may support techniques for reducing overhead while decreasing the signaling between one or more UEs and network entities. That is, the UE or the network entity may implement codebook-based interference compression and decompression to compress predicted interference measurements and reduce constant signaling to report interference measurements. As such, the codebook-based interference compression scheme described herein may lower the complexity and the power consumption for a wireless communication system.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of efficient codebook-based interference prediction reporting as described herein, or the processor 940 and the memory 930 may be otherwise configured to perform or support such operations.

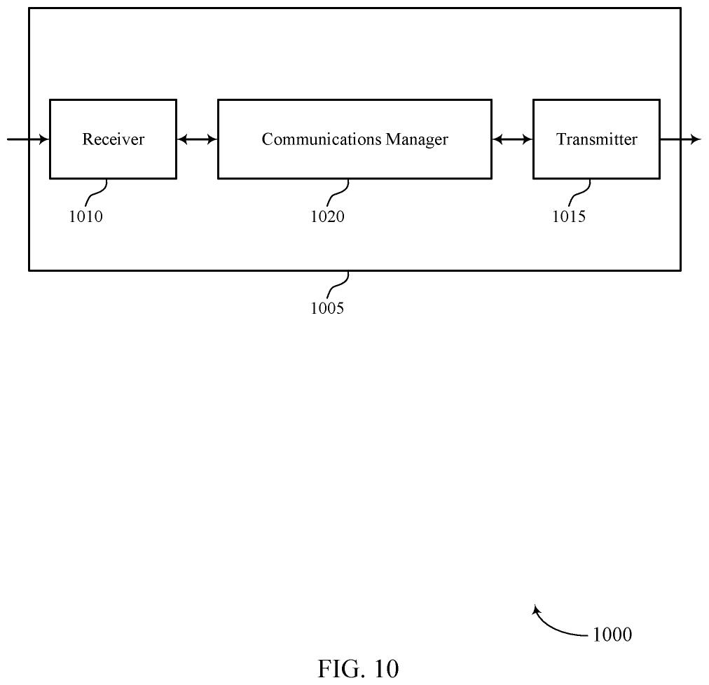

FIG. 10 shows a block diagram 1000 of a device 1005 that supports efficient codebook-based interference prediction reporting in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of efficient codebook-based interference prediction reporting as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 is capable of, configured to, or operable to support a means for transmitting a control message indicating a set of multiple resources for which a UE is to predict interference information. The communications manager 1020 is capable of, configured to, or operable to support a means for transmitting an indication of a set of multiple codebooks for compressing the interference information based on the set of multiple resources associated with the interference information. The communications manager 1020 is capable of, configured to, or operable to support a means for receiving a report indicating the interference information, where the interference information is compressed using a codebook of the set of multiple codebooks.

Additionally, or alternatively, the communications manager 1020 may support wireless communications at a network entity in accordance with examples as disclosed herein. For example, the communications manager 1020 is capable of, configured to, or operable to support a means for predicting interference information for a set of multiple resources. The communications manager 1020 is capable of, configured to, or operable to support a means for selecting a codebook from a set of multiple codebooks to compress the interference information based on the set of multiple resources associated with the interference information. The communications manager 1020 is capable of, configured to, or operable to support a means for transmitting a report indicating the interference information, where the interference information is compressed using the codebook.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced overhead and efficient interference measurement reporting.

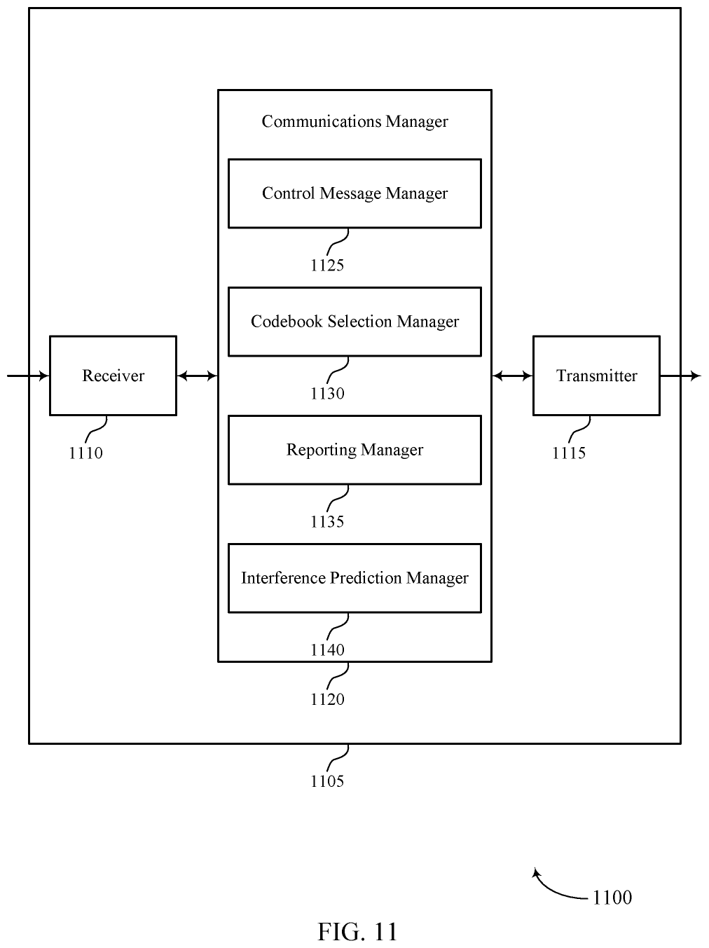

FIG. 11 shows a block diagram 1100 of a device 1105 that supports efficient codebook-based interference prediction reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these managers may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other managers of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other managers of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various managers thereof, may be an example of means for performing various aspects of efficient codebook-based interference prediction reporting as described herein. For example, the communications manager 1120 may include a control message manager 1125, a codebook selection manager 1130, a reporting manager 1135, an interference prediction manager 1140, or any combination thereof. The communications manager 1120 may be an example of aspects of a communications manager 1020 as described herein. In some examples, the communications manager 1120, or various managers thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The control message manager 1125 is capable of, configured to, or operable to support a means for transmitting a control message indicating a set of multiple resources for which a UE is to predict interference information. The codebook selection manager 1130 is capable of, configured to, or operable to support a means for transmitting an indication of a set of multiple codebooks for compressing the interference information based on the set of multiple resources associated with the interference information. The reporting manager 1135 is capable of, configured to, or operable to support a means for receiving a report indicating the interference information, where the interference information is compressed using a codebook of the set of multiple codebooks.

Additionally, or alternatively, the communications manager 1120 may support wireless communications at a network entity in accordance with examples as disclosed herein. The interference prediction manager 1140 is capable of, configured to, or operable to support a means for predicting interference information for a set of multiple resources. The codebook selection manager 1130 is capable of, configured to, or operable to support a means for selecting a codebook from a set of multiple codebooks to compress the interference information based on the set of multiple resources associated with the interference information. The reporting manager 1135 is capable of, configured to, or operable to support a means for transmitting a report indicating the interference information, where the interference information is compressed using the codebook.

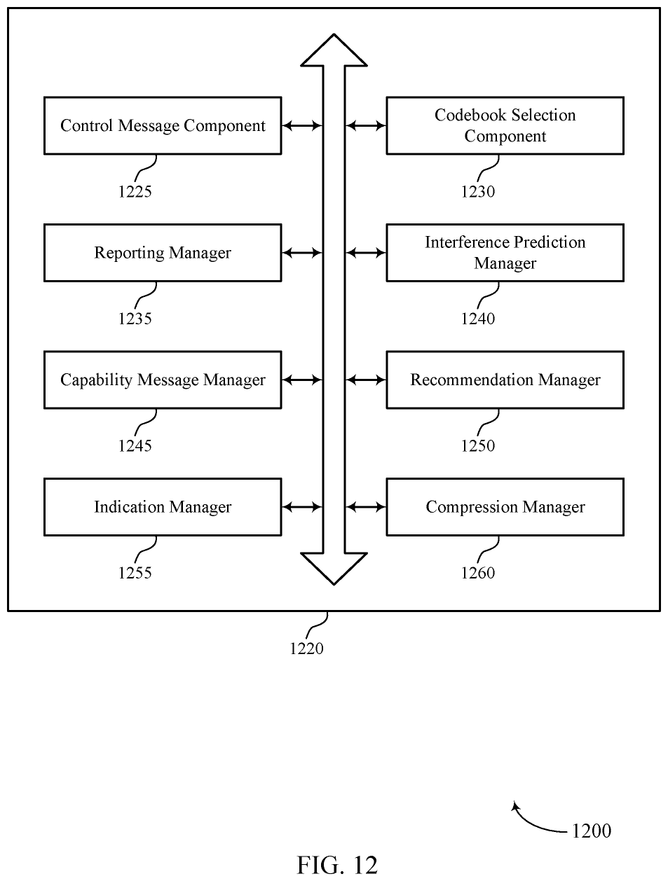

FIG. 12 shows a block diagram 1200 of a communications manager 1220 that supports efficient codebook-based interference prediction reporting in accordance with one or more aspects of the present disclosure. The communications manager 1220 may be an example of aspects of a communications manager 1020, a communications manager 1120, or both, as described herein. The communications manager 1220, or various managers thereof, may be an example of means for performing various aspects of efficient codebook-based interference prediction reporting as described herein. For example, the communications manager 1220 may include a control message manager 1225, a codebook selection manager 1230, a reporting manager 1235, an interference prediction manager 1240, a capability message manager 1245, a recommendation manager 1250, an indication manager 1255, or any combination thereof. Each of these managers may communicate, directly or indirectly, with one another (e.g., via one or more buses) which may include communications within a protocol layer of a protocol stack, communications associated with a logical channel of a protocol stack (e.g., between protocol layers of a protocol stack, within a device, manager, or virtualized manager associated with a network entity 105, between devices, managers, or virtualized managers associated with a network entity 105), or any combination thereof.

The communications manager 1220 may support wireless communications at a network entity in accordance with examples as disclosed herein. The control message manager 1225 is capable of, configured to, or operable to support a means for transmitting a control message indicating a set of multiple resources for which a UE is to predict interference information. The codebook selection manager 1230 is capable of, configured to, or operable to support a means for transmitting an indication of a set of multiple codebooks for compressing the interference information based on the set of multiple resources associated with the interference information. The reporting manager 1235 is capable of, configured to, or operable to support a means for receiving a report indicating the interference information, where the interference information is compressed using a codebook of the set of multiple codebooks.

In some examples, the capability message manager 1245 is capable of, configured to, or operable to support a means for receiving a capability message indicating a capability of the UE to support using the codebook to compress the interference information.

In some examples, the capability message indicates one or more codebook indices corresponding to one or more codebooks that the UE supports for compressing the interference information.

In some examples, each codebook of the set of multiple codebooks is defined based on a correlation between the interference information and a quantity of codewords of the codebook.

In some examples, each codebook of the set of multiple codebooks is associated with a different quantity of resources of the set of multiple resources for which the interference information is compressed.

In some examples, the codebook is selected based on the set of multiple resources being within a time period. In some examples, the codebook is selected based on the set of multiple resources being within a range of frequency bands.

In some examples, the codebook is selected based on the set of multiple resources being within a range of beams. In some examples, the codebook is selected based on a subset of the set of multiple resources being within a time period, a range of frequency bands, a range of beams, or any combination thereof.

In some examples, the recommendation manager 1250 is capable of, configured to, or operable to support a means for receiving a message recommending the codebook for compressing the interference information based on the interference information, where the control message indicates the recommended codebook.

In some examples, the recommendation manager 1250 is capable of, configured to, or operable to support a means for receiving a message recommending a minimum separation between a subset of resources of the set of multiple resources, where the subset of resources are to be grouped together in a same codeword of the codebook based on the interference information, and where the minimum separation is in a time domain, a frequency domain, a spatial domain, or any combination thereof. In some examples, the control message manager 1225 is capable of, configured to, or operable to support a means for transmitting the control message indicating the subset of resources in accordance with the recommended minimum separation.

In some examples, the recommendation manager 1250 is capable of, configured to, or operable to support a means for receiving a message recommending a subset of resources of the set of multiple resources that are to be grouped together in a same codeword of the codebook based on the interference information. In some examples, the control message manager 1225 is capable of, configured to, or operable to support a means for transmitting the control message indicating the recommended subset of resources.

In some examples, a resource of the set of multiple resources is defined by a time domain parameter, a frequency domain parameter, a spatial domain parameter, or a combination thereof. In some examples, a subset of codebooks of the set of multiple codebooks are associated the resource based on one or more of the time domain parameter, the frequency domain parameter, and the spatial domain parameter.

In some examples, the codebook is defined based on a set of environmental conditions and a separation between each resource of the set of multiple resources in a time domain, a frequency domain, a spatial domain, or a combination thereof.

In some examples, the indication manager 1255 is capable of, configured to, or operable to support a means for transmitting an indication to switch from using the selected codebook to using a different codebook for compressing the interference information.

In some examples, the indication manager 1255 is capable of, configured to, or operable to support a means for transmitting an indication of a set of codewords for the codebook, where the set of codewords are based on a set of environmental conditions and a separation between each resource of the set of multiple resources.

Additionally, or alternatively, the communications manager 1220 may support wireless communications at a network entity in accordance with examples as disclosed herein. The interference prediction manager 1240 is capable of, configured to, or operable to support a means for predicting interference information for a set of multiple resources. In some examples, the codebook selection manager 1230 is capable of, configured to, or operable to support a means for selecting a codebook from a set of multiple codebooks to compress the interference information based on the set of multiple resources associated with the interference information. In some examples, the reporting manager 1235 is capable of, configured to, or operable to support a means for transmitting a report indicating the interference information, where the interference information is compressed using the codebook.

In some examples, each codebook of the set of multiple codebooks is defined based on a correlation between the interference information and a quantity of codewords of the codebook.

In some examples, each codebook is associated with a different quantity of resources of the set of multiple resources for which the interference information is compressed. In some examples, the codebook is selected based on the set of multiple resources being within a time period.

In some examples, the codebook is selected based on the set of multiple resources being within a range of frequency bands. In some examples, the codebook is selected based on the set of multiple resources being within a range of beams.

In some examples, the codebook is selected based on a subset of the set of multiple resources being within a time period, a range of frequency bands, a range of beams, or any combination thereof.

In some examples, the compression manager 1260 is capable of, configured to, or operable to support a means for compressing the interference information using the codebook that is selected based on the set of multiple resources associated with the interference information.

In some examples, the codebook is defined based on a set of environmental conditions and a separation between each resource of the set of multiple resources in a time domain, a frequency domain, a spatial domain, or a combination thereof. In some examples, the set of multiple resources vary in a time domain, a frequency domain, a spatial domain, or a combination thereof.

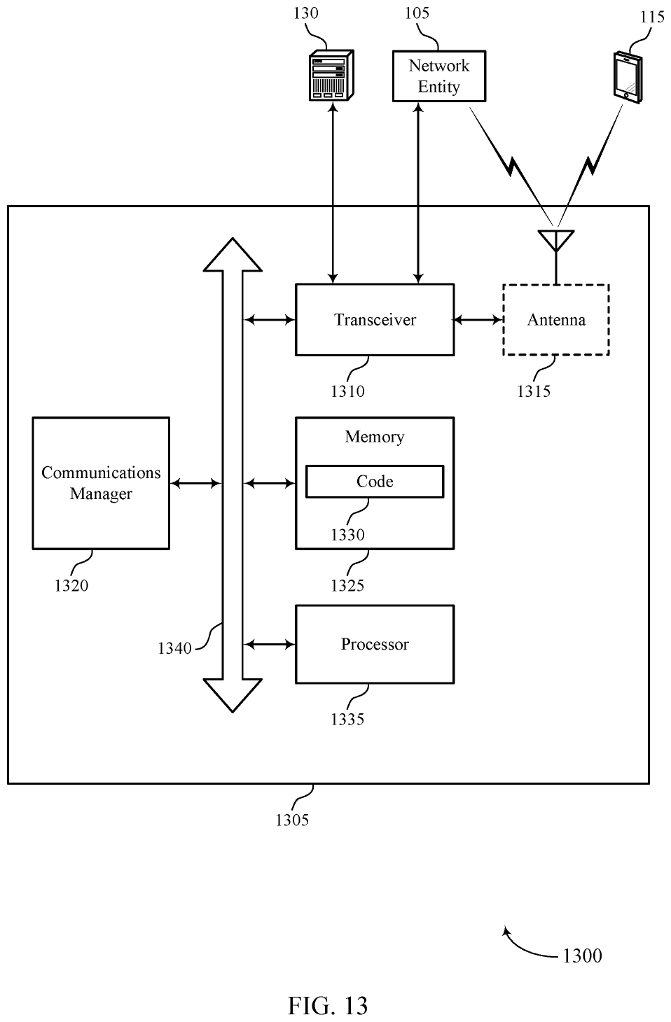

FIG. 13 shows a diagram of a system 1300 including a device 1305 that supports efficient codebook-based interference prediction reporting in accordance with one or more aspects of the present disclosure. The device 1305 may be an example of or include the managers of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include managers that support outputting and obtaining communications, such as a communications manager 1320, a transceiver 1310, an antenna 1315, a memory 1325, code 1330, and a processor 1335. These managers may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory managers that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory managers (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral managers or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware manager, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting efficient codebook-based interference prediction reporting). For example, the device 1305 or a manager of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a manager of a processing system. A processing system may generally refer to a system or series of machines or managers that receives inputs and processes the inputs to produce a set of outputs (which may be passed to other systems or managers of, for example, the device 1305). For example, a processing system of the device 1305 may refer to a system including the various other managers or submanagers of the device 1305, such as the processor 1335, or the transceiver 1310, or the communications manager 1320, or other managers or combinations of managers of the device 1305. The processing system of the device 1305 may interface with other managers of the device 1305, and may process information received from other managers (such as inputs or signals) or output information to other managers. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a manager of the device 1305, or between different managers of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different managers or divided between different managers).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 is capable of, configured to, or operable to support a means for transmitting a control message indicating a set of multiple resources for which a UE is to predict interference information. The communications manager 1320 is capable of, configured to, or operable to support a means for transmitting an indication of a set of multiple codebooks for compressing the interference information based on the set of multiple resources associated with the interference information. The communications manager 1320 is capable of, configured to, or operable to support a means for receiving a report indicating the interference information, where the interference information is compressed using a codebook of the set of multiple codebooks.

Additionally, or alternatively, the communications manager 1320 may support wireless communications at a network entity in accordance with examples as disclosed herein. For example, the communications manager 1320 is capable of, configured to, or operable to support a means for predicting interference information for a set of multiple resources. The communications manager 1320 is capable of, configured to, or operable to support a means for selecting a codebook from a set of multiple codebooks to compress the interference information based on the set of multiple resources associated with the interference information. The communications manager 1320 is capable of, configured to, or operable to support a means for transmitting a report indicating the interference information, where the interference information is compressed using the codebook.

By including or configuring the communications manager 1320 in accordance with examples as described herein, the device 1305 may support techniques for improved interference measurement reporting while reducing power consumption and constant signaling. That is, a wireless communication system supporting codebook-based interference compression techniques may benefit from low complexity, efficient compression, and flexible design.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate manager, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of efficient codebook-based interference prediction reporting as described herein, or the processor 1335 and the memory 1325 may be otherwise configured to perform or support such operations.

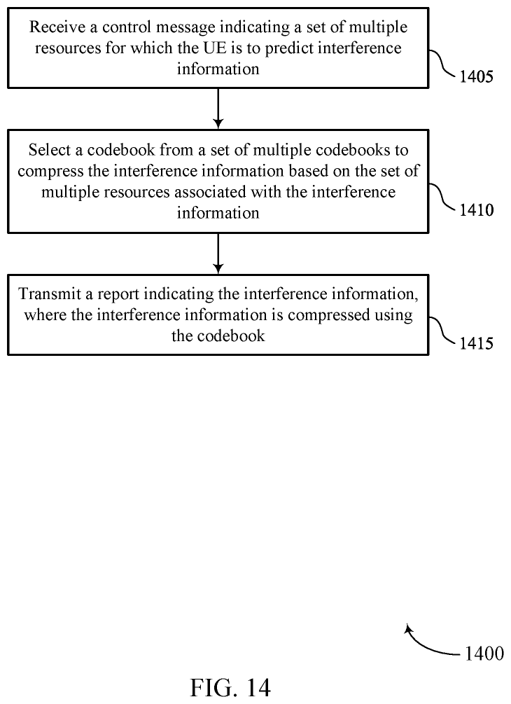

FIG. 14 shows a flowchart illustrating a method 1400 that supports efficient codebook-based interference prediction reporting in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a control message indicating a set of multiple resources for which the UE is to predict interference information. The operations of 1405 may be performed in accordance with examples as disclosed herein. In some examples, aspects of the operations of 1405 may be performed by a control message component 825 as described with reference to FIG. 8.

At 1410, the method may include selecting a codebook from a set of multiple codebooks to compress the interference information based on the set of multiple resources associated with the interference information. The operations of 1410 may be performed in accordance with examples as disclosed herein. In some examples, aspects of the operations of 1410 may be performed by a codebook selection component 830 as described with reference to FIG. 8.

At 1415, the method may include transmitting a report indicating the interference information, where the interference information is compressed using the codebook. The operations of 1415 may be performed in accordance with examples as disclosed herein. In some examples, aspects of the operations of 1415 may be performed by a reporting component 835 as described with reference to FIG. 8.

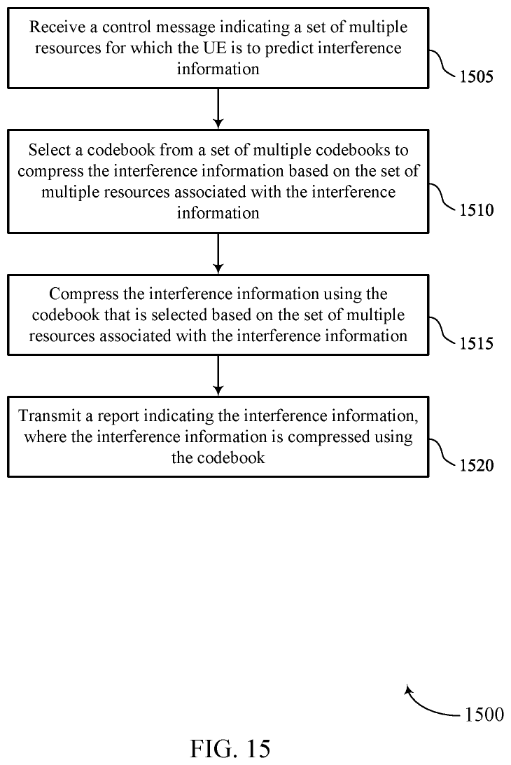

FIG. 15 shows a flowchart illustrating a method 1500 that supports efficient codebook-based interference prediction reporting in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a control message indicating a set of multiple resources for which the UE is to predict interference information. The operations of 1505 may be performed in accordance with examples as disclosed herein. In some examples, aspects of the operations of 1505 may be performed by a control message component 825 as described with reference to FIG. 8.

At 1510, the method may include selecting a codebook from a set of multiple codebooks to compress the interference information based on the set of multiple resources associated with the interference information. The operations of 1510 may be performed in accordance with examples as disclosed herein. In some examples, aspects of the operations of 1510 may be performed by a codebook selection component 830 as described with reference to FIG. 8.

At 1515, the method may include compressing the interference information using the codebook that is selected based on the set of multiple resources associated with the interference information. The operations of 1515 may be performed in accordance with examples as disclosed herein. In some examples, aspects of the operations of 1515 may be performed by a compression component 840 as described with reference to FIG. 8.

At 1520, the method may include transmitting a report indicating the interference information, where the interference information is compressed using the codebook. The operations of 1520 may be performed in accordance with examples as disclosed herein. In some examples, aspects of the operations of 1520 may be performed by a reporting component 835 as described with reference to FIG. 8.

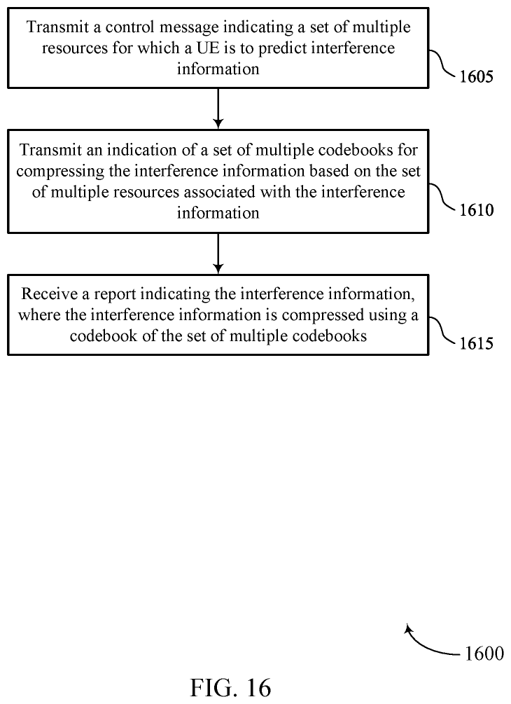

FIG. 16 shows a flowchart illustrating a method 1600 that supports efficient codebook-based interference prediction reporting in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include transmitting a control message indicating a set of multiple resources for which a UE is to predict interference information. The operations of 1605 may be performed in accordance with examples as disclosed herein. In some examples, aspects of the operations of 1605 may be performed by a control message manager 1225 as described with reference to FIG. 12.

At 1610, the method may include transmitting an indication of a set of multiple codebooks for compressing the interference information based on the set of multiple resources associated with the interference information. The operations of 1610 may be performed in accordance with examples as disclosed herein. In some examples, aspects of the operations of 1610 may be performed by a codebook selection manager 1230 as described with reference to FIG. 12.

At 1615, the method may include receiving a report indicating the interference information, where the interference information is compressed using a codebook of the set of multiple codebooks. The operations of 1615 may be performed in accordance with examples as disclosed herein. In some examples, aspects of the operations of 1615 may be performed by a reporting manager 1235 as described with reference to FIG. 12.

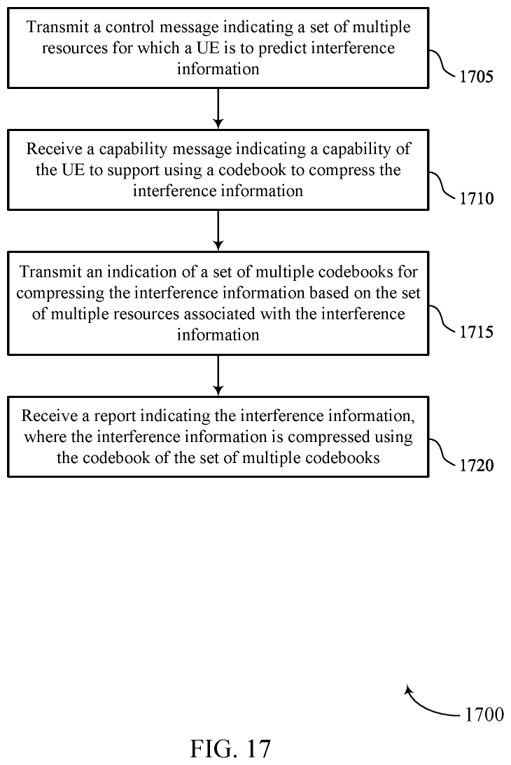

FIG. 17 shows a flowchart illustrating a method 1700 that supports efficient codebook-based interference prediction reporting in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include transmitting a control message indicating a set of multiple resources for which a UE is to predict interference information. The operations of 1705 may be performed in accordance with examples as disclosed herein. In some examples, aspects of the operations of 1705 may be performed by a control message manager 1225 as described with reference to FIG. 12.

At 1710, the method may include receiving a capability message indicating a capability of the UE to support using a codebook to compress the interference information. The operations of 1710 may be performed in accordance with examples as disclosed herein. In some examples, aspects of the operations of 1710 may be performed by a capability message manager 1245 as described with reference to FIG. 12.

At 1715, the method may include transmitting an indication of a set of multiple codebooks for compressing the interference information based on the set of multiple resources associated with the interference information. The operations of 1715 may be performed in accordance with examples as disclosed herein. In some examples, aspects of the operations of 1715 may be performed by a codebook selection manager 1230 as described with reference to FIG. 12.

At 1720, the method may include receiving a report indicating the interference information, where the interference information is compressed using the codebook of the set of multiple codebooks. The operations of 1720 may be performed in accordance with examples as disclosed herein. In some examples, aspects of the operations of 1720 may be performed by a reporting manager 1235 as described with reference to FIG. 12.

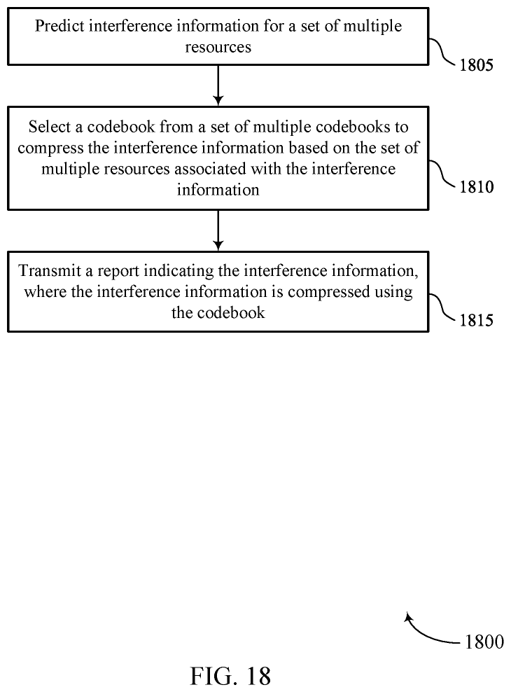

FIG. 18 shows a flowchart illustrating a method 1800 that supports efficient codebook-based interference prediction reporting in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include predicting interference information for a set of multiple resources. The operations of 1805 may be performed in accordance with examples as disclosed herein. In some examples, aspects of the operations of 1805 may be performed by an interference prediction manager 1240 as described with reference to FIG. 12.

At 1810, the method may include selecting a codebook from a set of multiple codebooks to compress the interference information based on the set of multiple resources associated with the interference information. The operations of 1810 may be performed in accordance with examples as disclosed herein. In some examples, aspects of the operations of 1810 may be performed by a codebook selection manager 1230 as described with reference to FIG. 12.

At 1815, the method may include transmitting a report indicating the interference information, where the interference information is compressed using the codebook. The operations of 1815 may be performed in accordance with examples as disclosed herein. In some examples, aspects of the operations of 1815 may be performed by a reporting manager 1235 as described with reference to FIG. 12.

The following provides an overview of aspects of the present disclosure:

Aspect 1: A method for wireless communications at a UE, comprising: receiving a control message indicating a plurality of resources for which the UE is to predict interference information; selecting a codebook from a plurality of codebooks to compress the interference information based at least in part on the plurality of resources associated with the interference information; and transmitting a report indicating the interference information, wherein the interference information is compressed using the codebook.

Aspect 2: The method of aspect 1, further comprising: compressing the interference information using the codebook that is selected based at least in part on the plurality of resources associated with the interference information.

Aspect 3: The method of any of aspects 1 through 2, further comprising: transmitting a capability message indicating a capability of the UE to support using the codebook to compress the interference information; and predicting the interference information based at least in part on transmitting the capability message.

Aspect 4: The method of aspect 3, wherein the capability message indicates one or more codebook indices corresponding to one or more codebooks that the UE supports for compressing the interference information.

Aspect 5: The method of any of aspects 1 through 4, wherein each codebook of the plurality of codebooks is defined based at least in part on a correlation between the interference information and a quantity of codewords of the codebook.

Aspect 6: The method of any of aspects 1 through 5, wherein each codebook of the plurality of codebooks is associated with a different quantity of resources of the plurality of resources for which the interference information is compressed.

Aspect 7: The method of any of aspects 1 through 6, wherein the codebook is selected based at least in part on the plurality of resources being within a time period.

Aspect 8: The method of any of aspects 1 through 7, wherein the codebook is selected based at least in part on the plurality of resources being within a range of frequency bands.

Aspect 9: The method of any of aspects 1 through 8, wherein the codebook is selected based at least in part on the plurality of resources being within a range of beams.

Aspect 10: The method of any of aspects 1 through 9, wherein the codebook is selected based at least in part on a subset of the plurality of resources being within a time period, a range of frequency bands, a range of beams, or any combination thereof.

Aspect 11: The method of any of aspects 1 through 10, further comprising: transmitting a message recommending the codebook for compressing the interference information based at least in part on the interference information, wherein the control message indicates the recommended codebook.

Aspect 12: The method of any of aspects 1 through 11, further comprising: transmitting a message recommending a minimum separation between a subset of resources of the plurality of resources, wherein the subset of resources are to be grouped together in a same codeword of the codebook based at least in part on the interference information, and wherein the minimum separation is in a time domain, a frequency domain, a spatial domain, or any combination thereof; and receiving the control message indicating the subset of resources in accordance with the recommended minimum separation.

Aspect 13: The method of any of aspects 1 through 12, further comprising: transmitting a message recommending a subset of resources of the plurality of resources that are to be grouped together in a same codeword of the codebook based at least in part on the interference information; and receiving the control message indicating the recommended subset of resources.

Aspect 14: The method of any of aspects 1 through 13, wherein a resource of the plurality of resources is defined by a time domain parameter, a frequency domain parameter, a spatial domain parameter, or a combination thereof, and a subset of codebooks of a plurality of codebooks are associated the resource based at least in part on one or more of the time domain parameter, the frequency domain parameter, and the spatial domain parameter.

Aspect 15: The method of any of aspects 1 through 14, wherein the codebook is defined based at least in part on a set of environmental conditions and a separation between each resource of the plurality of resources in a time domain, a frequency domain, a spatial domain, or a combination thereof.

Aspect 16: The method of any of aspects 1 through 15, further comprising: receiving an indication to switch from using the selected codebook to using a different codebook for compressing the interference information.

Aspect 17: The method of any of aspects 1 through 16, further comprising: receiving an indication of a set of codewords for the codebook, wherein the set of codewords are based at least in part on a set of environmental conditions and a separation between each resource of the plurality of resources.

Aspect 18: A method for wireless communications at a network entity, comprising: transmitting a control message indicating a plurality of resources for which a UE is to predict interference information; transmitting an indication of a plurality of codebooks for compressing the interference information based at least in part on the plurality of resources associated with the interference information; and receiving a report indicating the interference information, wherein the interference information is compressed using a codebook of the plurality of codebooks.

Aspect 19: The method of aspect 18, further comprising: receiving a capability message indicating a capability of the UE to support using the codebook to compress the interference information.

Aspect 20: The method of aspect 19, wherein the capability message indicates one or more codebook indices corresponding to one or more codebooks that the UE supports for compressing the interference information.

Aspect 21: The method of any of aspects 18 through 20, wherein each codebook of the plurality of codebooks is defined based at least in part on a correlation between the interference information and a quantity of codewords of the codebook.

Aspect 22: The method of any of aspects 18 through 21, wherein each codebook of the plurality of codebooks is associated with a different quantity of resources of the plurality of resources for which the interference information is compressed.

Aspect 23: The method of any of aspects 18 through 22, wherein the codebook is selected based at least in part on the plurality of resources being within a time period.

Aspect 24: The method of any of aspects 18 through 23, wherein the codebook is selected based at least in part on the plurality of resources being within a range of frequency bands.

Aspect 25: The method of any of aspects 18 through 24, wherein the codebook is selected based at least in part on the plurality of resources being within a range of beams.

Aspect 26: The method of any of aspects 18 through 25, wherein the codebook is selected based at least in part on a subset of the plurality of resources being within a time period, a range of frequency bands, a range of beams, or any combination thereof.

Aspect 27: The method of any of aspects 18 through 26, further comprising: receiving a message recommending the codebook for compressing the interference information based at least in part on the interference information, wherein the control message indicates the recommended codebook.

Aspect 28: The method of any of aspects 18 through 27, further comprising: receiving a message recommending a minimum separation between a subset of resources of the plurality of resources, wherein the subset of resources are to be grouped together in a same codeword of the codebook based at least in part on the interference information, and wherein the minimum separation is in a time domain, a frequency domain, a spatial domain, or any combination thereof; and transmitting the control message indicating the subset of resources in accordance with the recommended minimum separation.

Aspect 29: The method of any of aspects 18 through 28, further comprising: receiving a message recommending a subset of resources of the plurality of resources that are to be grouped together in a same codeword of the codebook based at least in part on the interference information; and transmitting the control message indicating the recommended subset of resources.

Aspect 30: The method of any of aspects 18 through 29, wherein a resource of the plurality of resources is defined by a time domain parameter, a frequency domain parameter, a spatial domain parameter, or a combination thereof, and a subset of codebooks of a plurality of codebooks are associated the resource based at least in part on one or more of the time domain parameter, the frequency domain parameter, and the spatial domain parameter.

Aspect 31: The method of any of aspects 18 through 30, wherein the codebook is defined based at least in part on a set of environmental conditions and a separation between each resource of the plurality of resources in a time domain, a frequency domain, a spatial domain, or a combination thereof.

Aspect 32: The method of any of aspects 18 through 31, further comprising: transmitting an indication to switch from using the selected codebook to using a different codebook for compressing the interference information.

Aspect 33: The method of any of aspects 18 through 32, further comprising: transmitting an indication of a set of codewords for the codebook, wherein the set of codewords are based at least in part on a set of environmental conditions and a separation between each resource of the plurality of resources.

Aspect 34: A method for wireless communications at a network entity, comprising: predicting interference information for a plurality of resources; selecting a codebook from a plurality of codebooks to compress the interference information based at least in part on the plurality of resources associated with the interference information; and transmitting a report indicating the interference information, wherein the interference information is compressed using the codebook.

Aspect 35: The method of aspect 34, wherein each codebook of the plurality of codebooks is defined based at least in part on a correlation between the interference information and a quantity of codewords of the codebook.

Aspect 36: The method of any of aspects 34 through 35, wherein each codebook is associated with a different quantity of resources of the plurality of resources for which the interference information is compressed.

Aspect 37: The method of any of aspects 34 through 36, wherein the codebook is selected based at least in part on the plurality of resources being within a time period.

Aspect 38: The method of any of aspects 34 through 37, wherein the codebook is selected based at least in part on the plurality of resources being within a range of frequency bands.

Aspect 39: The method of any of aspects 34 through 38, wherein the codebook is selected based at least in part on the plurality of resources being within a range of beams.

Aspect 40: The method of any of aspects 34 through 39, wherein the codebook is selected based at least in part on a subset of the plurality of resources being within a time period, a range of frequency bands, a range of beams, or any combination thereof.

Aspect 41: The method of any of aspects 34 through 40, further comprising: compressing the interference information using the codebook that is selected based at least in part on the plurality of resources associated with the interference information.

Aspect 42: The method of any of aspects 34 through 41, wherein the codebook is defined based at least in part on a set of environmental conditions and a separation between each resource of the plurality of resources in a time domain, a frequency domain, a spatial domain, or a combination thereof.

Aspect 43: The method of any of aspects 34 through 42, wherein the plurality of resources vary in a time domain, a frequency domain, a spatial domain, or a combination thereof.

Aspect 44: An apparatus for wireless communications at a UE, comprising a processor; memory coupled with the processor; and instructions stored in the memory and executable by the processor to cause the apparatus to perform a method of any of aspects 1 through 17.

Aspect 45: An apparatus for wireless communications at a UE, comprising at least one means for performing a method of any of aspects 1 through 17.

Aspect 46: A non-transitory computer-readable medium storing code for wireless communications at a UE, the code comprising instructions executable by a processor to perform a method of any of aspects 1 through 17.

Aspect 47: An apparatus for wireless communications at a network entity, comprising a processor; memory coupled with the processor; and instructions stored in the memory and executable by the processor to cause the apparatus to perform a method of any of aspects 18 through 33.

Aspect 48: An apparatus for wireless communications at a network entity, comprising at least one means for performing a method of any of aspects 18 through 33.

Aspect 49: A non-transitory computer-readable medium storing code for wireless communications at a network entity, the code comprising instructions executable by a processor to perform a method of any of aspects 18 through 33.

Aspect 50: An apparatus for wireless communications at a network entity, comprising a processor; memory coupled with the processor; and instructions stored in the memory and executable by the processor to cause the apparatus to perform a method of any of aspects 34 through 43.

Aspect 51: An apparatus for wireless communications at a network entity, comprising at least one means for performing a method of any of aspects 34 through 43.

Aspect 52: A non-transitory computer-readable medium storing code for wireless communications at a network entity, the code comprising instructions executable by a processor to perform a method of any of aspects 34 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a control message indicating a plurality of resources for which the UE is to predict interference information;
select a codebook from a plurality of codebooks to compress the interference information based at least in part on the plurality of resources associated with the interference information; and
transmit a report indicating the interference information, wherein the interference information is compressed using the codebook.

2. The apparatus of claim 1, wherein the instructions are further executable by the processor to cause the apparatus to:
compress the interference information using the codebook that is selected based at least in part on the plurality of resources associated with the interference information.

3. The apparatus of claim 1, wherein the instructions are further executable by the processor to cause the apparatus to:
transmit a capability message indicating a capability of the UE to support using the codebook to compress the interference information; and
predict the interference information based at least in part on transmitting the capability message.

4. The apparatus of claim 3, wherein the capability message indicates one or more codebook indices corresponding to one or more codebooks that the UE supports for compressing the interference information.

5. The apparatus of claim 1, wherein each codebook of the plurality of codebooks is defined based at least in part on a correlation between the interference information and a quantity of codewords of the codebook.

6. The apparatus of claim 1, wherein each codebook of the plurality of codebooks is associated with a different quantity of resources of the plurality of resources for which the interference information is compressed.

7. The apparatus of claim 1, wherein the codebook is selected based at least in part on the plurality of resources being within a time period.

8. The apparatus of claim 1, wherein the codebook is selected based at least in part on the plurality of resources being within a range of frequency bands.

9. The apparatus of claim 1, wherein the codebook is selected based at least in part on the plurality of resources being within a range of beams.

10. The apparatus of claim 1, wherein the codebook is selected based at least in part on a subset of the plurality of resources being within a time period, a range of frequency bands, a range of beams, or any combination thereof.

11. The apparatus of claim 1, wherein the instructions are further executable by the processor to cause the apparatus to:
transmit a message recommending the codebook for compressing the interference information based at least in part on the interference information, wherein the control message indicates the recommended codebook.

12. The apparatus of claim 1, wherein the instructions are further executable by the processor to cause the apparatus to:
transmit a message recommending a minimum separation between a subset of resources of the plurality of resources, wherein the subset of resources are to be grouped together in a same codeword of the codebook based at least in part on the interference information, and wherein the minimum separation is in a time domain, a frequency domain, a spatial domain, or any combination thereof; and
receive the control message indicating the subset of resources in accordance with the recommended minimum separation.

13. The apparatus of claim 1, wherein the instructions are further executable by the processor to cause the apparatus to:
transmit a message recommending a subset of resources of the plurality of resources that are to be grouped together in a same codeword of the codebook based at least in part on the interference information; and
receive the control message indicating the recommended subset of resources.

14. The apparatus of claim 1, wherein:
a resource of the plurality of resources is defined by a time domain parameter, a frequency domain parameter, a spatial domain parameter, or a combination thereof, and
a subset of codebooks of the plurality of codebooks are associated the resource based at least in part on one or more of the time domain parameter, the frequency domain parameter, and the spatial domain parameter.

15. The apparatus of claim 1, wherein the codebook is defined based at least in part on a set of environmental conditions and a separation between each resource of the plurality of resources in a time domain, a frequency domain, a spatial domain, or a combination thereof.

16. The apparatus of claim 1, wherein the instructions are further executable by the processor to cause the apparatus to:
receive an indication to switch from using the selected codebook to using a different codebook for compressing the interference information.

17. The apparatus of claim 1, wherein the instructions are further executable by the processor to cause the apparatus to:
receive an indication of a set of codewords for the codebook, wherein the set of codewords are based at least in part on a set of environmental conditions and a separation between each resource of the plurality of resources.

18. An apparatus for wireless communications at a network entity, comprising:
a processor;
memory coupled with the processor; and
instructions stored in the memory and executable by the processor to cause the apparatus to:
transmit a control message indicating a plurality of resources for which a user equipment (UE) is to predict interference information;
transmit an indication of a plurality of codebooks for compressing the interference information based at least in part on the plurality of resources associated with the interference information; and
receive a report indicating the interference information, wherein the interference information is compressed using a codebook of the plurality of codebooks.

19. The apparatus of claim 18, wherein the instructions are further executable by the processor to cause the apparatus to:
receive a capability message indicating a capability of the UE to support using the codebook to compress the interference information.

20. The apparatus of claim 19, wherein the capability message indicates one or more codebook indices corresponding to one or more codebooks that the UE supports for compressing the interference information.

21. The apparatus of claim 18, wherein each codebook of the plurality of codebooks is defined based at least in part on a correlation between the interference information and a quantity of codewords of the codebook.

22. The apparatus of claim 18, wherein each codebook of the plurality of codebooks is associated with a different quantity of resources of the plurality of resources for which the interference information is compressed.

23. The apparatus of claim 18, wherein the codebook is selected based at least in part on the plurality of resources being within a time period.

24. The apparatus of claim 18, wherein the codebook is selected based at least in part on the plurality of resources being within a range of frequency bands.

25. An apparatus for wireless communications at a network entity, comprising:
a processor;
memory coupled with the processor; and
instructions stored in the memory and executable by the processor to cause the apparatus to:
predict interference information for a plurality of resources;
select a codebook from a plurality of codebooks to compress the interference information based at least in part on the plurality of resources associated with the interference information; and
transmit a report indicating the interference information, wherein the interference information is compressed using the codebook.

26. The apparatus of claim 25, wherein each codebook of the plurality of codebooks is defined based at least in part on a correlation between the interference information and a quantity of codewords of the codebook.

27. The apparatus of claim 25, wherein each codebook is associated with a different quantity of resources of the plurality of resources for which the interference information is compressed.

28. The apparatus of claim 25, wherein the codebook is selected based at least in part on the plurality of resources being within a time period.

29. The apparatus of claim 25, wherein the codebook is selected based at least in part on the plurality of resources being within a range of frequency bands.

30. A method for wireless communications at a user equipment (UE), comprising:
receiving a control message indicating a plurality of resources for which the UE is to predict interference information;
selecting a codebook from a plurality of codebooks to compress the interference information based at least in part on the plurality of resources associated with the interference information; and
transmitting a report indicating the interference information, wherein the interference information is compressed using the codebook.
